(19) United States
(12) Patent Application Publication
(10) Pub. No.: US 2011/0206811 A1
(43) Pub. Date: Aug. 25, 2011

(54) SEMI-SOLID HONEY-BASED PRODUCTS

(75) Inventors: Yaelle Sarig, Tel-Aviv (IL); Oded Sarig, Tel-aviv (IL); Eli Siegler, Haifa (IL)

(73) Assignee: Natural Bits Food Design Ltd., Tel-Aviv (IL)

(21) Appl. No.: 13/127,484

(22) PCT Filed: Nov. 4, 2009
(86) PCT No.: PCT/IL2009/001029

§ 371 Date: May 4, 2011

Related U.S. Application Data
(60) Provisional application No. 61/111,001, filed on Nov. 4, 2008.

(51) Int. Cl. A23L 1/08; A23L 1/0532; A23L 1/0524; A23L 1/035; A23L 1/30

(52) U.S. Cl. 426/87; 426/575; 426/103

(57) ABSTRACT

Provided are semi-solid honey-based compositions and honey-based products produced therefrom, which can be used, for example, as household sweeteners, candies and/or snacks, and exhibit several consistency variants, such as a soft and spreadable, jelly-like or spoonable product, solid and rubbery handleable product, all designed for rapid dissolution in hot aqueous media, and a snack bar variant having non-soluble, solid food bits such as nuts, fruit bits, cereals and the likes. Also provided are processes of manufacturing the semi-solid honey-based compositions.

### FIELD AND BACKGROUND OF THE INVENTION

The present invention, in some embodiments thereof, relates to food products, and, more particularly, but not exclusively, to semi-solid honey-based food products, which can be used, for example, as household sweeteners or, when combined with additional ingredients, as snack bars and other food products.

Honey is a sweet, sticky and viscous fluid, which is produced by bees, typically from the nectar of flowers (honeydew), which is further enriched and modified by materials from the bees' bodies. Comb honey is produced by honeybees in a hive. The bees fill the hexagon shaped wax cells of the honeycomb with honey and cap it with beeswax. Before the invention of the honey extractor almost all honey produced was in the form of comb honey, however these days only very little honey is produced and marketed as comb honey, and the majority of commercial honey is produced as a filtered and purified liquid honey.

Honey is predominantly used for human consumption in its purified yet natural form, and in addition it is used as a sweetener in pastry and sweets, as well as the sugar source in the production of alcoholic beverages, such as mead. Honey is also regarded as having medicinal qualities, and is therefore used for internal as well as external traditional medicinal purposes. The importance of honey as a food, savory snack or as a medicine is primarily based on its content of easily absorbable carbohydrates, vitamins, minerals, anti-oxidants and aromatic substances which sooth and stimulate appetite.

In medicine, honey serves as a strengthening substance for convalescents because of its high nutritional value. In slowly healing wounds, honey acts as an anti-inflammatory as well as an antibacterial agent. It is also used traditionally as a home remedy in the treatment of bronchial catarrh. Of special importance from a medical viewpoint is the presence in honey of acetylcholine, a neurotransmitter which, as a cholinergic factor, acts to lower the blood pressure, and has a stimulating effect on stomach and bowel activities. Its immediate effect on the heart is presumably based on the restoration of the heart muscle metabolism or a rebuilding of the energy reserves of the heart muscle. Furthermore, honey is used in the diet for liver conditions and particularly in chronic liver diseases.

Traditional manufacturing processes require treatment of confectionery ingredients at high heats for extended time periods. Such processes have a deleterious effect on some of the beneficial properties of honey, specifically the anti-oxidant components present in honey.

Honey requires care and suitable handling and storage conditions in order to preserve its qualities. Being a thick and sticky, yet sensitive, fluid, the commercial aspects of honey production and everyday use are non-trivial, and thus the ever-growing world-wide production and composition of the honey increases the need for improved containment, conveyance, packaging, marketing and serving solutions, which will overcome the technical difficulties in handling honey as well as preserving its beneficial characteristics.

Despite its highly appreciated and widely recognized beneficial qualities, honey is oftentimes not the first choice of sweetener in most households, mainly due to its sticky and viscous consistency, rendering its use cumbersome and dirtying.

U.S. Pat. No. 1,182,116 teaches the manufacturing of cubed comb honey effected by freezing the comb honey prior to cutting and wrapping the resulting cubes.

U.S. Pat. No. 2,021,450 teaches heating honey under reduced pressure so as to allow some of the water to evaporate while not overheating the honey, and allowing it to cool down at certain humidity, in order to obtain hard, glassy solid honey.

U.S. Pat. No. 2,902,370 teaches packaged chunk comb honey and the prevention or delaying of crystallization or granulation of such honey by coating the comb honey chunks with a solid film of an edible material such as pectins and pectinates.

U.S. Pat. No. 3,950,551 teaches dehydrated sugary syrups, such as honey, in the form of dried flakes or ground flakes, obtained by thin film drying of an extrudable mixture of a syrup and un-gelatinized starch and/or moistened soy protein and/or aqueous solution of the sugary syrup, and optionally a small amount of edible oil, effected at temperatures of 75° F. to 180° F., until the moisture content is reduced to approximately 1.0-4.0% by weight.

U.S. Pat. No. 5,356,650 teaches a process for producing solid honey which is effected by pre-heating raw honey to a temperature of 35°-40° C., filtering the pre-heated honey to produce pure honey, dehydrating the pure honey under reduced pressure while gradually and continuously raising the temperature to a final temperature of about 90° C., pouring the heated concentrated pure honey into a molding cavity having applied thereto an oil effective to prevent adhesion of the honey to the molding cavity, and allowing the honey to cool and solidify within the molding cavity.

U.S. Pat. No. 6,610,337, and U.S. Patent Application Publication Nos. 20040126463 and 20070071808 teach a process of producing drops of honey in a capsule made of hydroxymethylcellulose that is filled with the honey, as well as a food product in which these capsules dissolve in boiling water, and allows the honey to escape into the beverage of choice, such as tea.

EP Patent No. 0381806 teaches jellied food products consisting of a jelly-like substance and a cream- or jam-like substance incorporated into the central portion in the jelly-like substance contained in a can in a state where both substances are not mixed until the time when the can is opened.

U.S. Pat. No. 3,908,027 and GB 1360465 teach jelly-like foods, and preparation thereof, which are characterized by an elastic skin (55-88% of total weight) and a pasty or liquid core which contains 1.5 to 6% by weight or volume of a polysaccharide which is thermally gelable, and mainly consists of β-1,3-pyranoglucose.

NL 7400889, GB 0148456 and GB 0156445 teach the preparation of encapsulated drops of fruit material, coated with gelled pectate or alginate, and useful as imitation berry fruit.

U.S. Pat. No. 4,529,608 teaches a manufacturing process of honey powder while preserving the natural aroma substances of honey, which are released during consumption. This process is effected by mixing honey with starch, pre-hydrolyzed starch or flour and cyclodextrin, drying the mixture by heat or lyphilization, adding hydrophobic colloidal silicic acid or alkali earth stearate and grinding it to a powder.

WO Publication No. 01/67888 (PCT/NZ01/00041) teaches methods of manufacture, apparatus for manufacturing and final honey-based products. These honey-based products are produced by combining a quantity of thickening agent with a solvent to produce a gelling agent, mixing the gelling agent with honey, and reducing the solvent content of the honey-gelling agent mixture to achieve a honey based product including more than 90% honey by weight of the combined honey-gelling agent mixture. These honey-based products have application as confectionery products, such as edible honey leather, chewy bars, chewing gums and the like, jelly-type and jam-like products, as well as wound dressings and internal and external therapeutic uses.

U.S. Pat. No. 6,077,557 and U.S. Patent Application Publication No. 20030008054, teach calcium slurries comprising calcium phosphate salts and propylene glycol and/or glycerin, which are added to other materials such as sugars and fruit purees to form a gel, which is then further processed into shaped pieces, cured and dried to form finished calcium fortified gelled food pieces. The curing step involves the formation of the gel structure of the gelling agents, and optional heating of the products to remove excess moisture and eventual cooling down of the products to form a gel that is able to withhold its individual shape.

U.S. Pat. Nos. 6,458,405 and 6,663,910 teach sweet gelled food products which are characterized by 55-85% nutritive carbohydrate sweetener in content by weight, 10-20% moisture, and a gelling system that provides 1-8 kg/cm² structural strength. In these patents, the gelling system comprises high methoxy pectin and kappa carrageenan, which allows for a high solids level and a low viscosity (thermo-stable) when maintained above 54° C.

### SUMMARY OF THE INVENTION

The present invention, in some embodiments thereof, relates to semi-solid honey-based products, which can be used, for example, as a household sweetener and/or a snack. According to some embodiments of the invention, a specific formulation of the honey-based products promotes high solubility of the product in hot aqueous media. The semi-solid honey-based products presented herein can contain, apart from honey, other sugar sources, such as fruit-, grain- and vegetable-derived carbohydrates, saccharides and polysaccharides, as well other flavorings, odoriferous and coloring agents. The semi-solid honey-based products can exhibit several consistency variants, such as a soft and spreadable, jelly-like or spoonable product, solid and rubbery handleable product, both designed for rapid dissolution in hot aqueous media such as hot beverages, and a snack bar variant having solid food bits such as nuts, fruit bits, cereals and the likes.

According to an aspect of some embodiments of the present invention there is provided a honey-based composition comprising:

a natural honey at a concentration ranging from 40 to 85 percents by weight of the total weight of the composition;

a carrageenan at a concentration ranging from 0.6 to 1.5 percents by weight of the total weight of the composition;

a pectin at a concentration ranging from 0.4 to 1.5 percents by weight of the total weight of the composition;

an acidic buffer at a concentration ranging from 0.5 to 2 percents by weight of the total weight of the composition; and

an emulsifier at a concentration ranging from 0.2 to 1.0 percent by weight of the total weight of the composition.

According to some embodiments of the invention, the honey-based composition further comprises a thermo-reversible gelling agent at a concentration ranging from 0.01 to 0.5 percents by weight of the total weight of the composition.

According to some embodiments of the invention, the honey-based composition further comprises a thickening agent at a concentration ranging from 0.001 to 0.1 percents by weight of the total weight of the composition.

According to some embodiments of the invention, the honey-based composition is characterized by a water activity that ranges from 0.6 to 0.8.

According to some embodiments of the invention, the honey-based composition is characterized by a degree Brix that ranges from 76° Bx to 83° Bx.

According to some embodiments of the invention, the honey-based composition is highly dissolvable in hot aqueous media.

According to some embodiments of the invention, a sample of 12 grams of the composition dissolves in 100 ml of water at a temperature ranging from 70° C. to 95° C. within a time period that ranges from 60 seconds to 20 seconds.

According to some embodiments of the invention, the carrageenan is kappa-carrageenan.

According to some embodiments of the invention, the pectin is selected from the group consisting of a low ester pectin (LEP), a rapid-set high ester pectin (RSHEP) and a slow-set high ester pectin (SSHEP).

According to some embodiments of the invention, the acidic buffer comprises trisodium citrate and citric acid.

According to some embodiments of the invention, a concentration of the trisodium citrate ranges from 0.3 to 0.6 percent by weight of the total weight of the composition.

According to some embodiments of the invention, the citric acid is in a form of a 50% aqueous solution and a content thereof ranges from 0.6 to 1.4 percent by weight of the total weight of the composition.

According to some embodiments of the invention, the emulsifier is a sucrose-fatty acid ester.

According to some embodiments of the invention, the honey-based composition further comprises an additional sugar source.

According to some embodiments of the invention, a concentration of the additional sugar source ranges from 0.1 to 45 percent by weight of the total weight of the composition.

According to some embodiments of the invention, the additional sugar source is selected from the group consisting of a monosaccharide, a disaccharide, sucrose, invert sugar, dextrose, lactose, maltose, fructose, maple syrup, corn syrup, corn syrup solids, a fruit or vegetable juice, a fruit or vegetable concentrate, a fruit or vegetable solid and any combination thereof.

According to some embodiments of the invention, the honey-based composition further comprising an additional ingredient selected from the group consisting of an additional gelling agent, a thickening agent, a solid and insoluble food ingredient, an aeration agent, a flavoring agent, an odoriferous agent, a colorant, a preservative, a moisture stabilizing agent, a foaming agent, an antifoaming agent and any combination thereof.

According to some embodiments of the invention, a concentration of the additional gelling agent ranges from 0.01 to 1 percent by weight of the total weight of the composition.

According to some embodiments of the invention, the additional gelling agent is selected from the group consisting of a thermo-reversible gelling agent, arabinoxylan, cellulose, carboxymethylcellulose, curdlan, gellan gum (E418), guar gum, gum arabic, starch, xanthan gum (E415), alginic acid (E400), sodium alginate (E401), potassium alginate (E402), ammonium alginate (E403), calcium alginate (E404), agar, agarose (E406), locust bean gum (E410), gelatin (E441) and any combination thereof.

According to some embodiments of the invention, the aeration agent is selected from the group consisting of powdered ammonium carbonate and sodium bicarbonate.

According to some embodiments of the invention, a concentration of the aeration agent ranges from 0.01 to 0.05 percent by weight of the total weight of the composition.

According to some embodiments of the invention, the solid and insoluble food ingredient is selected from the group consisting of whole, chopped, natural, malted, puffed, rolled and/or roasted nuts, cereals and grains.

According to some embodiments of the invention, the honey-based composition is identified for use in the manufacture of a product selected from the group consisting of a comestible confectionery product, a dietary supplement, a cosmetic product and a pharmaceutical product.

According to an aspect of some embodiments of the present invention there is provided a honey-based product comprising the composition described hereinabove.

According to an aspect of some embodiments of the present invention there is provided a honey-based composition comprising:

natural honey at a concentration ranging from 40 to 85 percent by weight of the total weight of the composition;

kappa-carrageenan at a concentration ranging from 0.6 to 1.5 percent by weight of the total weight of the composition;

a slow-setting pectin at a concentration ranging from 0.4 to 1.5 percent by weight of the total weight of the composition;

a thermo-reversible gelling agent at a concentration ranging from 0.1 to 0.5 percent by weight of the total weight of the composition;

an acidic buffer at a concentration ranging from 0.5 to 2 percent by weight of the total weight of the composition; and

an emulsifier at a concentration ranging from 0.4 to 1.0 percent by weight of the total weight of the composition;

the composition being highly dissolvable in hot aqueous media.

According to some embodiments of the invention, a sample of 12 grams of the composition dissolves in 100 ml of water at a temperature ranging from 70° C. to 95° C. within a time period that ranges from 40 seconds to 20 seconds.

According to some embodiments of the invention, the composition is characterized by a water activity that ranges from 0.6 to 0.7.

According to some embodiments of the invention, the composition is characterized by a degree Brix that ranges from 76° Bx to 83° Bx.

According to some embodiments of the invention, the thermo-reversible gelling agent is a low-acyl gellan gum.

According to some embodiments of the invention, the acidic buffer comprises trisodium citrate and citric acid.

According to some embodiments of the invention, a concentration of the trisodium citrate ranges from 0.3 to 0.6 percent by weight of the total weight of the composition.

According to some embodiments of the invention, the citric acid is in a form of a 50% aqueous solution and a content thereof ranges from 0.6 to 1.4 percent by weight of the total weight of the composition.

According to some embodiments of the invention, the emulsifier is a sucrose-fatty acid ester.

According to some embodiments of the invention, the composition further comprising fructose.

According to some embodiments of the invention, a concentration of the fructose ranges from 10 to 25 percent by weight of the total weight of the composition.

According to an aspect of some embodiments of the present invention there is provided a honey-based product comprising the composition described herein, the product being a spoonable honey-based product.

According to an aspect of some embodiments of the present invention there is provided a honey-based composition comprising:

natural honey at a concentration ranging from 40 to 85 percent by weight of the total weight of the composition;

kappa-carrageenan at a concentration ranging from 0.6 to 1.5 percent by weight of the total weight of the composition;

a slow-setting pectin at a concentration ranging from 0.4 to 1.5 percent by weight of the total weight of the composition;

an acidic buffer at a concentration ranging from 0.5 to 2 percent by weight of the total weight of the composition; and

an emulsifier at a concentration ranging from 0.2 to 0.4 percent by weight of the total weight of the composition;

the composition being highly dissolvable in hot aqueous media.

According to some embodiments of the invention, a sample of 12 grams of the composition dissolves in 100 ml of water at a temperature ranging from 70° C. to 95° C. within a time period that ranges from 60 seconds to 30 seconds.

According to some embodiments of the invention, the composition is characterized by a water activity that ranges from 0.6 to 0.7.

According to some embodiments of the invention, the composition is characterized by a degree Brix that ranges from 76° Bx to 83° Bx.

According to some embodiments of the invention, the composition is characterized by springiness that ranges from 50 percents to 70 percents.

According to some embodiments of the invention, the composition is characterized by cohesiveness that ranges from 0.2 to 0.7.

According to some embodiments of the invention, the acidic buffer comprises trisodium citrate and citric acid.

According to some embodiments of the invention, a concentration of the trisodium citrate ranges from 0.3 to 0.6 percent by weight of the total weight of the composition.

According to some embodiments of the invention, the citric acid is in a form of a 50% aqueous solution and a content thereof ranges from 0.6 to 1.4 percent by weight of the total weight of the composition.

According to some embodiments of the invention, the emulsifier is a sucrose-fatty acid ester.

According to some embodiments of the invention, the composition further comprising fructose.

According to some embodiments of the invention, a concentration of the fructose ranges from 10 to 25 percent by weight of the total weight of the composition.

According to some embodiments of the invention, the composition further comprising a fruit extract, a vegetable extract, a herb extract, a fruit juice concentrate and/or a vegetable juice concentrate.

According to some embodiments of the invention, the composition further comprises orange juice concentrate.

According to some embodiments of the invention, a concentration of the orange juice concentrate ranges from 10 to 15 percent by weight of the total weight of the composition.

According to some embodiments of the invention, the composition further comprises carrot extract.

According to some embodiments of the invention, the concentration of the carrot extract ranges from 1 to 5 percent by weight of the total weight of the composition.

According to some embodiments of the invention, the composition further comprises pomegranate juice concentrate.

According to some embodiments of the invention, a concentration of the pomegranate juice concentrate ranges from 10 to 15 percent by weight of the total weight of the composition.

According to some embodiments of the invention, the composition further comprises an aeration agent.

According to some embodiments of the invention, the aeration agent is selected from the group consisting of powdered ammonium carbonate and sodium bicarbonate.

According to some embodiments of the invention, the concentration of the aeration agent ranges from 0.01 to 0.05 percent by weight of the total weight of the composition.

According to an aspect of some embodiments of the present invention there is provided a honey-based product comprising the composition described hereinabove, the product being a handleable honey-based product.

According to an aspect of some embodiments of the present invention there is provided a honey-based composition comprising:

natural honey at a concentration ranging from 40 to 85 percent by weight of the total weight of the composition;

a solid and insoluble food ingredient at a content ranging from 0 to 30 percent by weight of the total weight of the composition;

kappa-carrageenan at a concentration ranging from 0.6 to 1.5 percent by weight of the total weight of the composition;

a rapid-setting pectin at a concentration ranging from 0.4 to 1.5 percent by weight of the total weight of the composition;

a thickening agent at a concentration ranging from 0.01 to 0.1 percent by weight of the total weight of the composition;

an acidic buffer at a concentration ranging from 0.5 to 2 percent by weight of the total weight of the composition; and

an emulsifier at a concentration ranging from 0.2 to 0.4 percent by weight of the total weight of the composition.

According to some embodiments of the invention, the solid and insoluble food ingredient is selected from the group consisting of whole, chopped, natural, malted, puffed, rolled and/or roasted fruits, nuts, cereals and grains.

According to some embodiments of the invention, the composition is characterized by a water activity that ranges from 0.65 to 0.7.

According to some embodiments of the invention, the composition is characterized by a degree Brix that ranges from 76° Bx to 83° Bx.

According to some embodiments of the invention, the thickening agent is xanthan gum.

According to some embodiments of the invention, the composition is characterized by springiness that ranges from 50 percents to 70 percents.

According to some embodiments of the invention, the composition is characterized by cohesiveness that ranges from 0.2 to 0.7.

According to some embodiments of the invention, the acidic buffer comprises trisodium citrate and citric acid.

According to some embodiments of the invention, a concentration of the trisodium citrate ranges from 0.3 to 0.6 percent by weight of the total weight of the composition.

According to some embodiments of the invention, the citric acid is in a form of a 50% aqueous solution and a content thereof ranges from 0.6 to 1.4 percent by weight of the total weight of the composition.

According to some embodiments of the invention, the emulsifier is a sucrose-fatty acid ester.

According to some embodiments of the invention, the composition further comprising fructose.

According to some embodiments of the invention, a concentration of the fructose ranges from 10 to 25 percent by weight of the total weight of the composition.

According to some embodiments of the invention, the composition further comprising an aeration agent.

According to some embodiments of the invention, the aeration agent is selected from the group consisting of powdered ammonium carbonate and sodium bicarbonate

According to some embodiments of the invention, a concentration of the aeration agent ranges from 0.01 to 0.05 percent by weight of the total weight of the composition.

According to an aspect of some embodiments of the present invention there is provided a honey-based product comprising the composition described hereinabove, the product being a snack-bar honey-based product.

According to some embodiments of the invention, the product further comprises a coating which comprises natural cellulose fibers.

According to some embodiments of the invention the honey-based composition or product described herein further comprising an additional ingredient selected from the group consisting of an additional gelling agent, an additional thickening agent, a flavoring agent, an odoriferous agent, a colorant, a preservative, a moisture stabilizing agent, and a foaming agent.

According to some embodiments of the invention, some of the honey-based product described herein is packaged in a packaging material.

According to some embodiments of the invention, the spoonable product described herein is packaged in a packaging material suitable for a spoonable product and identified as a sweetener or a spread.

According to some embodiments of the invention, the handleable or snack bar product described herein is packaged in a packaging material suitable for a handleable product and identified as a product selected from the group consisting of a sweetener, a confectionary, a candy and a snack bar.

According to an aspect of some embodiments of the present invention there is provided a process of manufacturing any of the honey-based compositions described herein, the process comprising:

heating the honey to about 60° C.;

admixing a dry powder of the carrageenan;

adding an aqueous solution which comprises the acidic buffer (optionally pre-heated), pectin (typically a pre-blended mix of dry pectins), the additional sugar source and the emulsifier, to thereby obtain a hot honey-based liquid formulation; and

reheating and stirring the hot honey-based liquid formulation to a temperature that ranges from 80-95° C., thereby obtaining the honey-based composition or product.

According to some embodiments of the invention, the process further comprising, prior to the adding, mixing, heating and solubilizing the aqueous solution.

According to some embodiments of the invention, the process further comprising, admixing an additional ingredient selected from the group consisting of an additional gelling agent, an aeration agent, a solid and insoluble food ingredient, a flavoring agent, an odoriferous agent, a colorant, a preservative, a moisture stabilizing agent, a foaming agent, an antifoaming agent and any combination thereof.

According to some embodiments of the invention, the process further comprising, subsequent to the reheating:

pouring the hot honey-based liquid formulation into a mold having a desired shape; and

cooling the hot honey-based liquid formulation to room temperature.

According to some embodiments of the invention, the process further comprising, subsequent to the cooling, coating the honey-based product in natural cellulose fibers.

As used herein the term “about” refers to ±10%.

The terms “comprises”, “comprising”, “includes”, “including”, “having” and their conjugates mean “including but not limited to”. The term “consisting of” means “including and limited to”.

The term “consisting essentially of means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a biomolecule” or “at least one biomolecule” may include a plurality of biomolecules, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

The terms “composition” and “formulation” are used herein interchangeably.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 presents a typical plot of applied force as a function of time, as obtain while exposing a sample of a solid honey-based product, according to some embodiments of the invention, to two compressing presses, using a texture analyzer device, wherein the compression cycles are marked as “Hardness 1” for the first compression cycle and “Hardness 2” for the second compression cycle;

FIG. 2 is a flow-chart presenting an exemplary process of preparing the handleable and molded honey-based products according to some embodiments of the present invention;

FIG. 3 is a flow-chart presenting an exemplary process of preparing the aerated handleable and molded honey-based products according to some embodiments of the present invention;

FIG. 4 is a flow-chart presenting an exemplary process of preparing the honey-based snack bar products according to some embodiments of the present invention; and

FIG. 5 is a flow-chart presenting an exemplary process of preparing the handleable honey-based products enriched with fruit juice according to some embodiments of the present invention.

### DESCRIPTION OF EMBODIMENTS OF THE INVENTION

The present invention, in some embodiments thereof, relates to food products, and, more particularly, but not exclusively, to semi-solid honey-based compositions and food products made therefrom, which can be used, for example, as household sweeteners or, when combined with additional ingredients, as snack bars and other food products.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

As presented hereinabove, honey has a historical and traditional household use, which is limited mostly due to the sticky, adhesive nature of this viscous and thick substance.

In an attempt at forming more manageable and handy products from honey, the present inventors have successfully formulated honey-based compositions, using carrageenan, pectins and other gelling, thickening, emulsifying and buffering agents, which can be designed, by selecting particular combinations and ratios of the above agents, to have a semi-solid rubbery texture or a semi-solid jelly texture.

As presented hereinbelow, these honey-based compositions can be utilized for producing honey-based products that can be easily handled by hand or by spoon without experiencing the typical stickiness of the highly adhesive natural honey.

In some embodiments, the honey-based compositions comprise a gelling agent which is non-adhesive and can dissolve rapidly in hot aqueous media, thus rendering the honey-based products made from such compositions highly suitable for use, with great ease, as a household sweetener.

According to an aspect of embodiments of the present invention, there is provided a honey-based composition, which comprises the following basic components:

natural honey at a concentration ranging from about 40 to about 85 percents by weight of the total weight of the composition;

carrageenan, used as a natural gelling agent, at a concentration ranging from about 0.6 to about 1.5 percent by weight of the total weight of the composition;

pectin, used as an additional natural gelling agent, at a concentration ranging from about 0.4 to about 1.5 percent by weight of the total weight of the composition;

an acidic buffer, used as an acidulant, at a concentration ranging from about 0.5 to about 2 percent by weight of the total weight of the composition; and

an emulsifier having a concentration ranging from about 0.2 to about 1.0 percent by weight of the total weight of the composition.

Such a honey-based composition can be used in a myriad of applications, such as in the manufacture of a comestible confectionery product per-se or in conjunction with other food stuffs, of dietary supplements, of cosmetic products and/or of pharmaceutical products, all being honey-based.

The honey-based compositions presented herein essentially comprise about 40% to about 85% by weight of natural honey. While the major component of the honey-based compositions is honey, other sugar sources can be added to the formulation in order to add color, taste and structural consistency to the final composition.

The phrase “sugar source”, as used herein, encompasses any carbohydrate-sweetening agent, as this term is known in the art, and is meant to include those typical natural, processed and/or purified sweetening agents, based on mono-, di-oligo- and/or poly-saccharides carbohydrates, conventionally used in food products. Exemplary Suitable materials for use as a sugar source include both monosaccharide and disaccharide sugars such as sucrose, invert sugar, dextrose, dextrans, lactose, maltose, fructose, maple syrup, corn syrup, high-fructose corn syrup, corn syrup solids, fruit and vegetable juices and concentrates thereof, fruit and vegetable solids, grain-derived sugars such as malt, grasses-derived sugars such as cane sugar, root-derived sugars such as beet sugar, and any combination thereof.

Sugar sources are to be distinguished from non-nutritive carbohydrate high potency sweetening agents such as saccharine, cyclamate, and the like, from such protein-based sweetening agents as aspartame, thaumatin and monellin.

The additional sugar source can be added to the honey-based composition up to a content of 45 percent by weight of the total weight of the composition.

In some embodiments, the honey-based compositions presented herein include fruit products. In such embodiments, the additional sugar source is being provided by or from fruit juices or fruit solids. The fruit solids can be derived from fruit purees or juices prepared from whole fruit flesh, or, if such purees have been partially dehydrated, fruit paste.

The term “puree”, as commonly used in the art, describes both heat treated, namely boiled, and untreated food pulp. As used herein, however, “puree” is meant to refer both to heated and unheated whole fruit pieces, which have been mechanically transformed into fluids. Thus, the comminuted fruit material can be distinguished from discrete individual pieces of intact fruit flesh.

The honey-based compositions according to some embodiments are characterized by several chemical characteristics and properties, such as:

a water activity level which ranges from about 0.6 to about 0.8; and/or

a degree Brix level which ranges from about 76° Bx to about 82° Bx.

Water activity (a_{w}) is quantifiable and temperature-dependent measure of energy of water in a system, which indicates the availability of water to interact with other components in the system and/or in the environment. Water activity is defined as the vapor pressure of water in the subject system, divided by vapor pressure of pure water at the same temperature. The capacity of water to interact with its environment stems from the combination of dipole-dipole, ionic, and hydrogen bonding interactions which exist between water molecules and other dissolved or undissolved components in the system. These interactions reduce the free energy of water and thus reduce the relative humidity as compared to pure water. These interactions affect water so as to appear “bound” by forces to varying degrees, and hence water activity is oftentimes described as “free”, “bound”, or “available water” in a system.

Water activity is an important consideration for food product design and food stability (shelf-life) and thus for the product's safety. Water activity is used as a criterion in the formulation of food products such that when a product is kept below a certain water activity, rot (mold and bacteria growth) and spoilage is inhibited, thus resulting in a longer shelf-life. Water-mediated food spoilage can also occur due to undesirable chemical reactions without the presence of active microbes, such as non-enzymatic browning, fat oxidation, vitamin degradation, enzymatic reactions, protein denaturation, starch gelatinization and starch retrogradation. Water activity is also used as a criterion for determining and predicting moisture migration within a food product made from ingredients of different texture, consistency and intrinsic moisture levels.

Degrees Brix (° Bx) is a measurement of the mass ratio of dissolved sugar to water in a liquid. For example, a solution which is characterized by 25° Bx is a 25% weight percentages sugar solution (25 grams of sugar and 75 grams of water in the 100 grams of aqueous solution).

As used herein, the phrase “gelling agent” refers to a wide ranged family of substances that can thicken and mechanically stabilize (thicken, jellify or solidify) a liquid solution. In some embodiments, a gelling agent is partly soluble or partially immiscible in the liquid medium it is meant to jellify, and therefore transforms it into a colloid mixture (a suspension or emulsion) or colloidal dispersion, as this term is defined hereinbelow, upon applying stress/heat/stirring/sonication, or in some cases allowing ambient temperature to act over a certain time period (e.g., minutes to days). A gelling agent can form a network-like structure, giving the resulting solution the consistency of a semi-solid while still being composed substantially of the liquid.

A colloid or colloidal dispersion is a type of homogenous mixture of two separate phases: a dispersed phase and a continuous phase. In a colloid, the dispersed phase is made of droplets that are distributed evenly throughout the continuous phase. Colloidal dispersions, which appear like solutions, are also referred to as colloidal aerosols, colloidal emulsions, colloidal foams, colloidal dispersions, or hydrosols. Many familiar substances, including butter, milk, cream, aerosols (fog, smog, smoke), asphalt, inks, paints, glues, and sea foam, are essentially colloids. Hydrocolloid is a common term used in the art to describe a substance that forms a gel with water.

The gelling agent, according to some embodiments of the invention, is safe for human consumption, namely, considered edible and non-deleterious for humans.

Common gelling agents include, for example, organic compounds such as synthetic polymers, polysaccharides, polypeptides and proteins, carbohydrates and dextrins, colloidal and hydrocolloidal dispersants, and minerals. Exemplary edible gelling agents which are suitable for use in the context of the embodiments of the invention, include, without limitation, polysaccharides derived from brown algae such as alginic acid (E400), sodium alginate (E401), potassium alginate (E402), ammonium alginate (E403), calcium alginate (E404), polysaccharide derived from red seaweeds such as agar and agarose (E406), carrageenan (E407), natural gums from land plants such as arabinoxylan, cellulose and carboxymethylcellulose, curdlan, gellan gum (E418), guar gum, gum arabic, starch and xanthan gum (E415), and locust bean gum (E410) which is a polysaccharides extracted from the carob tree seeds, pectin (E440) a polysaccharides extracted from apple or citrus fruits, and proteinous substances such as gelatin (E441) which is produced by partial hydrolysis of animal-derived collagen, and any combinations thereof and with other synthetic or mineral based substances suitable for use in food products.

It is noted herein that each gelling agent has a set of characteristic gelling qualities, such as setting time, setting shrinkage, setting conditions (temperature, ionic strength, ionic type and pH), physico-mechanical properties of the final gel (such as springiness, brittleness and cohesiveness), reversibility of the sol-to-gel transition (such as thermo-reversibility) and other chemical and mechanical properties. It is also noted that a composition comprising more than one gelling agent typically possesses unique characteristic gelling qualities which differ from the characteristic gelling qualities of each of the individual gelling agents in the composition or of other compositions.

A hydrocolloid is a colloid system wherein the colloid particles are dispersed in water or an aqueous solution. A hydrocolloid has colloid particles spread throughout water and depending on the quantity of water available can take on different states, e.g., gel or sol (liquid). Hydrocolloids can be either irreversible (single-state) or reversible. For example, carrageenan and agar are reversible hydrocolloids of seaweed extract, and can exist in a gel and sol state, and alternate between states with the addition or elimination of stress and/or heat. Other hydrocolloids may be affected also by pH and the presence of particular amounts and valency of ions. Many hydrocolloids are derived from natural sources. For example, carrageenan and agar are extracted from seaweed, gelatin is extracted from animals such as bovine, porcine and/or fish, and pectin is extracted from fruit products such as citrus peel and pomace (applesauce). Hydrocolloids are employed in food mainly to influence texture or viscosity. Hydrocolloids are also used in skin-care and wound-dressing.

The use of hydrocolloids in the food industry is both ancient and modern, with new substances and uses thereof constantly emerging alongside with research and growing understanding of their role in nature and practical use. Following is a brief introduction to two hydrocolloids which are relevant in the context of embodiments of the invention, based on the extensive work of Chaplin, M. F. [“Hydrocolloids and gums” in “Water Structure and Science”, 2008, Attribution-non-commercial-no derivative Works 2.0 UK, England & Wales].

As used herein, the term “pectin” describes a family of carbohydrate-based substances that are widely used as gelling agents, and constitute a heterogeneous group of acidic structural polysaccharides, found in fruit and vegetables, making up between about 2% and 35% of the plant's cell walls and is important for plant growth. development and defense. Pectins are extracted from plants, mostly fruits, and particularly from citrus peel and apple pomace. Pectin varieties are classified according to their degree of hydroxyl group esterification, which is the percent of hydroxyl groups that have been converted into an ester, essentially methoxy ester.

Pectins have complex structures that depend on their source and extraction methodology, and commercial extraction adds to this diversity by causing extensive degradation of the neutral sugar-containing side-chains. The majority of the structure consists of homopolymeric partially methylated poly-α-(14)-D-galacturonic acid residues (also referred to as “smooth”, see Scheme 1) but there are substantial “hairy”, non-gelling areas (see Scheme 1 below) of alternating α-(12)-L-rhamnosyl-α-(14)-D-galacturonosyl sections containing branch-points with mostly neutral side chains (1-20 residues) of mainly L-arabinose and D-galactose (rhamnogalacturonan I). [Chaplin, M. F., (2004) Carbohydrate Analysis. In Encyclopedia of Molecular Cell Biology and Molecular Medicine, R. A. Meyers (Ed.) Wiley-VCH, Weinheim, Vol. 2 pp. 243-275].

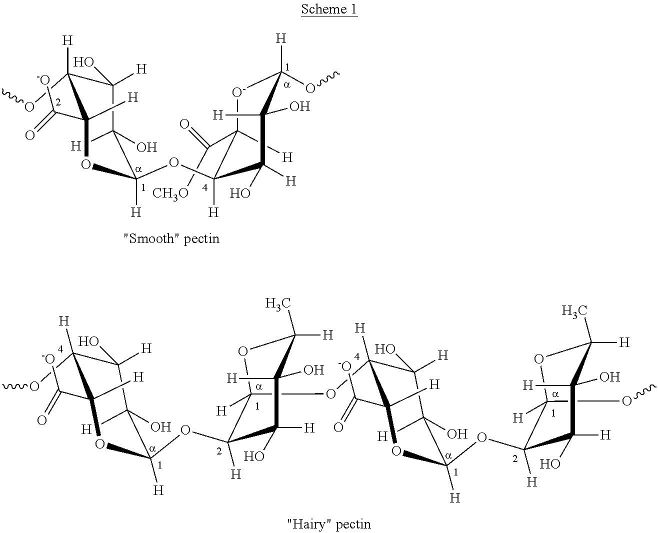

Pectins may also contain rhamnogalacturonan II side chains containing other residues such as D-xylose, L-fucose, D-glucuronic acid, D-apiose, 3-deoxy-D-manno-2-octulosonic acid (Kdo) and 3-deoxy-D-lyxo-2-heptulosonic acid (Dha) attached to poly-α-(14)-D-galacturonic acid regions [S. Pérez, M. A. Rodríguez-Carvajal and T. Doco, A complex plant cell wall polysaccharide: rhamnogalacturonan II. A structure in quest of a function. Biochimie 85 (2003) 109-121].

Pectins do not possess exact structures [S. Pérez, K. Mazeau and C. Hervé du Penhoat, The three-dimensional structures of the pectic polysaccharides, Plant Physiol. Biochem. 38 (2000) 37-55], with biosynthesis that requires at least 67 transferase enzymes [D. Mohnen, Pectin structure and biosynthesis, Curr. Opin. Plant Biol. 11 (2008) 266-277]. D-galacturonic acid residues form most of the pectin molecules, in blocks of “smooth” and “hairy” regions, shown in Scheme 1 above. Pectins do not adopt a straight conformation in solution, but rather extend, curve and twist with high flexibility while the “hairy” regions of pectins, having pendant arabinogalactans, contribute most of the flexibility. The carboxylate groups seen in Scheme 1 tend to expand the structure of pectins as a result of their charge, unless they interact through divalent cationic bridging, having a pKₐ of about 2.9 ensuring considerable negative charge under most circumstances [M-C. Ralet, V. Dronnet, H. C. Buchholt and J. F Thibault, Enzymatically and chemically de-esterified lime pectins: characterisation, polyelectrolyte behavior and calcium binding properties, Carbohydr. Res. 336 (2001) 117-125]. Methylation of these carboxylic acid groups forms their methyl esters, which take up a similar space but are much more hydrophobic and consequently have a different effect on the structuring of the surrounding water. The chemical and mechanical properties of pectins depend on the degree of esterification, which can range from as high as about 70% to as low as less than 40%.

Pectin-based gels are strongly affected by di-valent ions such as calcium. Gel strength increases with increasing Ca²⁺ concentration but reduces with temperature and acidity increase (pH less than 3). Low methoxy-pectins are more affected than high methoxy-pectins by the presence of di-cations such as calcium due to the lack of sufficient carboxylate groups in the highly esterified pectin. Thus, if the methoxy esterified content is greater than about 50%, calcium ions show some interaction but do not gel. Controlled removal of methoxyl groups, namely the conversion of high methoxy-pectins to low-methoxy pectins, is possible using pectin methylesterases but the reverse process is not easily achieved.

High methoxy-pectins (more than 43% esterified, and usually about 67%) gel by the formation of hydrogen-bonding and hydrophobic interactions in the presence of acids (pH about 3.0, to reduce electrostatic repulsions) and sugars (for example, about 62% sucrose by weight, to reduce polymer-water interactions) [A. Tsoga, R. K. Richardson and E. R. Morris, Role of cosolutes in gelation of high methoxy-pectin. Part 1. Comparison of sugars and polyols, Food Hydrocolloids 18 (2004) 907-919]. Low methoxy-pectins (about 35% esterified), in the absence of added cations, gel by the formation of cooperative “zipped” associations at low temperatures (about 10° C.) to form transparent gels [A.-L. Kjøniksen, M. Hiorth, B. Nyström, Temperature-induced association and gelation of aqueous solutions of pectin. A dynamic light scattering study. Eur. Polymer J. 40 (2004) 2427-2435]. The rheological properties of low methoxy-pectins are highly dependent on the salt cation, salt concentration and pH.

The degree of esterification is thus expressed in percents, and is highly correlated to the functional characteristics of the pectin substance. For example, below 50% esterification, pectins are referred to as low ester pectin (LEP), or low methoxy-pectin. LEP requires the presence of at least a low level of soluble calcium ions in order to set or form gels. In contrast, above 50% esterification, pectins are characterized as high ester pectin (HEP), or high methoxy pectin which does not require soluble calcium to set or form gels. LEP and HEP are further classified as being rapid or slow setting. For example, pectins of 70% to 75% esterification are also fast or rapid-setting, and pectins of 62% to 65% esterification are regarded as slow-setting pectins. Rapid-set high ester pectin is referred to herein as RSHEP, and slow-set high ester pectin is referred to herein as SSHEP. For a sense of the speed of setting, a high methoxyl rapid set pectin type with 73.5% esterification will solidify to form a gel at pH 3.0 at 85° C. in 10 minutes, and a slow-setting pectin with 64.5% esterification will form a gel at 65° C. in 30 minutes.

As is well known in the art, pectins, and particularly high ester pectin (HEP), slowly form irreversible gels, and earned them the name “slow set gelling agents”. Slow setting gelling agents require longer period of time to arrange their molecules into the network that constitutes the gel.

The property of speed of setting is important for industrial applications where the speed at which a gel forms determines many of the mechanical characteristics of the machinery and timing of the production line as well as the ability to use of molds with certain fine and detailed features. To put in simplified manner, the faster the gel forms, the faster the production line can go, but the lesser are the details which can be imprinted by the molds in or onto the gel's surface. For example, a rapid setting gelling agent is useful for food products containing insoluble solid particles which should be evenly spread in the interior of the gel and therefore a rapid gelling agent will set before these solid pieces subside to the bottom.

The irreversibility of the formed gel is another important property in industrial applications. If a gel is irreversible, it cannot be formed and reformed, by means of heating and cooling cycles, during the production process, and each step of the production is thus final with respect to the shape and consistency of the composition or product. Irreversibility is also important in determining practical usefulness of a gel in terms of, for example, its solubility in hot aqueous media.

According to some embodiments, the honey-based compositions may contain additional sources of sugars, such as fruit juices, fruit extracts and/or fruit solids. In these cases, the fruit ingredient will provide some amount of native pectins. Hence the reported amount of pectins in the formulations of the honey-based compositions presented herein is in addition to any pectin which stems from such fruit-born ingredients.

As used herein, the term “carrageenan” describes a family of structurally related highly flexible carbohydrate-based linear polymers or polysaccharide-based substances of about 25,000 galactose derivatives with regular but imprecise structures, dependent on the source and extraction conditions. Carrageenans are widely used in the food and other industries as gelling, thickening and stabilizing agents. Carrageenans are extracted from certain genera of red seaweeds, or carrageenophytes, such as Chondrus, Gigartina, Eucheuma, Furcellaria and Phyllophora. Carrageenans are highly sulfated and highly flexible galactans, namely have a structure of a linear polymer alternating with the repeating disaccharide, 1,3-linked-β-D-galactopyranosyl and 1,4-linked-α-D-galactosyl sugar residues (see, Scheme 2 below).

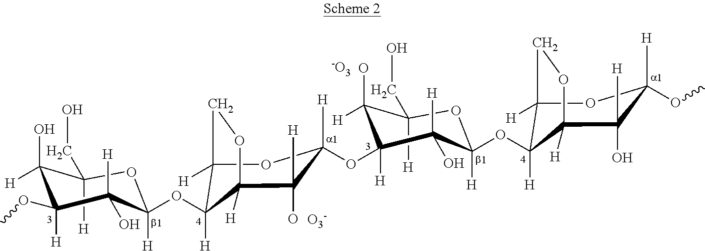

The presence of substitute groups, replacing hydroxyl groups, or other modifications of these disaccharide units, such as anhydride ring formation, gives rise to the structural variation exhibited in carrageenans, whereby these variations result in the formation of gels of varied consistency, hardness, springiness and cohesiveness at room temperature. Carrageenans are pseudoplastic, namely they thin under shear stress and/or heat and recover their viscosity once the stress and/or heat is removed. There are three main commercial classes of carrageenan, Kappa-carrageenan (κ-carrageenan, -(1→3)-β-D-galactopyranose-4-sulfate-(1→4)-3,6-anhydro-α-D-galactopyranose-(1→3)-) which forms strong, rigid gels, Iota-carrageenan (τ-carrageenan, -(1→3)-β-D-galactopyranose-4-sulfate-(1→4)-3,6-anhydro-α-D-galactopyranose-2-sulfate-(1→3)-) which forms soft gels, and Lambda-carrageenan (λ-carrageenan, -(1→3)-β-D-galactopyranose-2-sulfate-(1→4)-α-D-galactopyranose-2,6-disulfate-(1→3)-) which form gels when mixed with proteins rather than water, and is commonly used to thicken dairy products.

Idealized structures and basic chemical manipulation for obtaining the three main variants of carrageenan are given in Schemes 3 below.

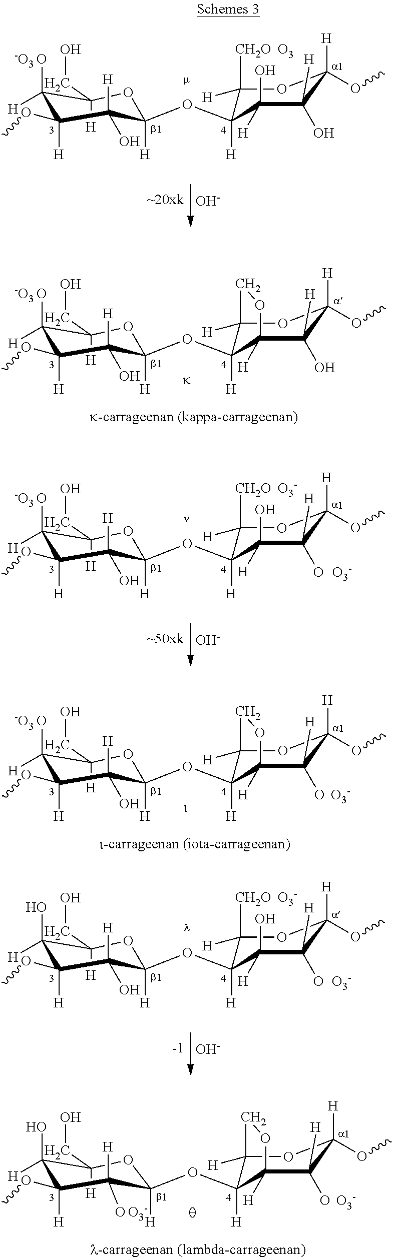

τ-carrageenan is produced by alkaline elimination from ν-carrageenan isolated mostly from the Philippines seaweed Eucheuma denticulatum (also called Spinosum). λ-carrageenan (isolated mainly from Gigartina pistillata or Chondrus crispus) is converted into θ-carrageenan (theta-carrageenan) by alkaline elimination, but at a much slower rate than causes the production of τ-carrageenan and κ-carrageenan.

κ-Carrageenan is produced by alkaline elimination from μ-carrageenan isolated mostly from the tropical seaweed Kappaphycus alvarezii (also known as Eucheuma cottonii). Since commercially available κ-carrageenan has been found to contain a small proportion of the dimer associated with τ-carrageenan, the phrase “kappa-carrageenan”, as used herein, is meant to encompass any commercially available kappa-carrageenan. Although kappa-carrageenan can be isolated in a pure form, commercially available kappa-carrageenans may contain some impurity levels of iota-carrageenan associated therewith.

Kappa-carrageenan is widely known in the art as a thermo-reversible gelling agent. A thermo-reversible gelling agent is such that can form (jellify or solidify to the gel state) and break (melt or liquefy to the sol state) reversibly in a cycle of sol-to-gel-to-sol which is effected by a cycle of cooling (sol-to-gel) and heating (gel-to-sol) and so on. In other words, a gel based on kappa-carrageenan can form from a heated solution containing kappa-carrageenan by allowing this solution to cool. Once this kappa-carrageenan based gel is set or partially set (full or partial sol-to-gel transition), this gel can be re-liquefied or melted to afford a solution when heat is applied to the gel (gel-to-sol transition). When allowed to cool again, this solution of re-liquefied gel can re-solidify to form a gel again (another full or partial sol-to-gel transition).

The wide variety of available gelling agents and variants thereof can be employed to produce honey-based compositions and products with a wide range of properties, each being optimal for different applications and uses. For example, a composition which is meant for high springiness and cohesiveness will include a gelling agent which forms a more rubbery and plastic gel, such as pectin; a composition which is meant for rapid dissolution in hot aqueous media will include a thermo-reversible gelling agent such as carrageenan; a composition which is meant for high speed molding will include a rapid-setting gelling agent; and a composition which is meant for high spreadability will include a gelling agent which forms a more brittle gel, such as gellan gum. Obviously some compositions are meant to have a combination of some of the above properties and other properties, and thus their optimal gelling system contains a particular combination of gelling agents.

According to some embodiments, the honey-based compositions presented herein may include an additional thermo-reversible gelling agent at a concentration ranging from 0.01 to 0.5 percents by weight of the total weight of the composition.

According to some embodiments, the honey-based compositions presented herein may include a thickening agent at a concentration ranging from 0.001 to 0.1 percents by weight of the total weight of the composition.

While reducing the present invention to practice, the present inventors have surprisingly uncovered that use of a balanced mixture of a slow setting irreversible gelling agent, such as high ester pectin (HEP), which slowly forms irreversible gels, and a fast setting reversible gelling agent, such as kappa-carrageenan, which rapidly forms a thermo-reversible gel, give rise to a semi-solid composition which can be mass produced in industrial scales as known in the art, and moreover, can be handled by hand (“handleable”) and/or spooned easily (“spoonable”) due to its practical mechanical properties, while preserving the ability to dissolve in hot aqueous media in a relatively short period of time, measured in seconds, by means of a simple swiveling motion such as afforded by a household spoon or teaspoon.

Hence, according to some embodiments of the invention, the honey-based compositions presented herein contain a mixture of both pectin and carrageenan among other optional gelling agents, being formulated such that the resulting composition is substantially a thermo-reversible gel, namely has the tendency to dissolve rapidly in hot water and yet maintaining its semi-solid consistency and shape at room temperature or below.

Products made of such honey-based compositions can replace commonly used household sweeteners such as refined and brown sugar, molasses, corn syrups and the likes.

The honey-based compositions are formulated to dissolve readily in hot aqueous media such as hot water. The phrase “hot aqueous media”, as used herein, is intended to encompass any hot aqueous solution such as plain water, brewed tea, brewed coffee and other hot beverages and drinks, being at a temperature that ranges from 70° C. to 95° C.

As demonstrated in the Examples section that follows, the present inventors have successfully produced a honey-based composition that dissolves readily and rapidly in hot water. For example, a sample of about 12 grams of an exemplary honey-based composition can dissolve, by means of a swiveling motion, in 100 ml of water at 90° C., in less than 20 seconds or otherwise within a time period which ranges from about 20 seconds to about 60 seconds.

Some of the honey-based compositions according to these embodiments are further characterized by several physico-mechanical characteristics and properties, such as:

a springiness level which ranges from about 50 percents to about 70 percents; and/or

a cohesiveness level which ranges from about 0.2 to about 0.7.

The physico-mechanical properties of some of the solid and semi-solid honey-based compositions according to embodiments of the invention, such as hardness, springiness and cohesiveness are indicative to the elasticity and general organoleptic impression, or mouth feel of the compositions. The parameters that can be associated with the elastic mouth feel of the compositions depend on the amount of energy which is required to break a sample in one exposure to direct mechanical pressure (compression in one direction). A composition or product made therefrom with low springiness will breaks readily after one exposure and will not regain its structure, as will be evident after a second exposure to pressure. Samples that do regain their original structure, at least partially, are said to possess high springiness levels, which is indicative of rapid and reversible textural reengagement. Such physico-mechanical properties as springiness and cohesiveness have been measured and compared for several exemplary honey-based compositions and products made therefrom, as presented in the Examples section that follows below.

Stability and firmness of hydrocolloid-based gels, such as pectin and carrageenan based gels, depend to some extent also on pH. Other factors which affect the stability and firmness of such gels include the degree Brix, cations such as calcium, magnesium and potassium, etc. Carrageenans form gel at an optimum pH values of 4.0 to 5.0. Below acidic pH 4.0, carrageenans gels start to degrade and the gels become unstable and weak. In contrast, pectin gels are stable and firm at low pH. This is explained partly by the increasing ratio of dissociated acid groups which generally make the pectin molecule more hydrophilic. High ester pectins normally require a pH of 3.5 and below to form a stable gel.

The taste and consistency of the honey-based compositions presented herein is affected by their pH level. Hence, the composition's formulation contains an acidic buffer system or acidulant, which serves as a taste factor as well as a gelling process factor.

According to some embodiments, an exemplary acidulant may include trisodium citrate and citric acid, combined to exert the desired pH in the final composition.

According to some embodiments, the concentration of the trisodium citrate ranges from 0.3 to 0.6 percent by weight of the total weight of the composition. The citric acid, according to some embodiments, is used in the form of a 50% aqueous solution, which is then added to a content that ranges from 0.6 to 1.4 percent by weight of the total weight of the final composition.

According to some embodiments, an emulsifying agent, or emulsifier, is used to endow the honey-based composition with the desired consistency as well as controlling its tendency to dissolve in water.

In some embodiments, the emulsifier is a sucrose fatty acid ester, used at the high end of the concentration range to obtain a softer, spreadable and more readily dissolvable composition.

Sucrose fatty acid ester (SE) is a type of non-ionic surfactant which has been used in the food industry as an additive emulsifier. The SE molecule has eight hydroxyl groups in the hydrophilic group, so it is possible to manufacture SE ranging widely from low hydrophilic-lipophilic balance (HLB) variety to high HLB variants by controlling the degree of esterification of the hydroxyl groups. The main characteristics of SE are oil-in-water and water-in-oil emulsifying properties, solubilizing and foaming properties, inhibition of ice crystal growth in fat, inhibition of retrogradation in starch, releasing property and prevention of flat-sour spoilage, making SE highly useful in the production of many food products, such as dairy products and baked goods.

The honey-based compositions of some embodiments of the invention may further include additional ingredients such as, for a non-limiting example, an additional gelling agent, an additional food ingredient (e.g., a solid and insoluble food ingredient), an aeration agent, a flavoring agent, an odoriferous agent, a colorant, a preservative, a moisture stabilizing agent, a foaming agent, an antifoaming agent and any combination thereof.

The phrases “flavoring agent” and “odoriferous agent”, as these are used herein, describe a class of food additive substances which are added to food products in order to induce a certain flavor or smell in the food product, and are commonly referred to herein as “flavorants”. Flavorants can be synthetic or natural extracts, which are extracted from a source substance. Typical flavorants are specific and often complex mixtures of singular naturally occurring or synthetic flavor compounds combined together to either imitate or enhance a natural flavor. Many flavorants are esters, which can be characterized by a typical flavor, such as, for some non-limiting examples, diacetyl which give a buttery flavor, isoamyl acetate is perceived as banana, cinnamic aldehyde is the basis for the typical flavor of cinnamon, ethyl propionate is perceived as fruity, limonene is perceived as orange, ethyl-(E,Z)-2,4-decadienoate is perceived as pear, allyl hexanoate is perceived as pineapple, ethyl maltol, is perceived as sugar or cotton candy, methyl salicylate is know as the wintergreen flavor, and benzaldehyde is perceived as bitter almond.

In some embodiments, the flavoring agent used in of a natural source and can be, for example, an extract of a fruit, a vegetable, herb or of any other edible substance, a fruit juice or a vegetable juice, or any combination thereof. Such natural flavoring agents are often considered also as providing an added nutritional value to a composition or product containing same.

The term “colorant”, as used herein, refers to any natural or synthetic food coloring substance, and describes any substance that is added to food or drink in order to alter its color. Exemplary food colorants include synthetic colorants such as FD&C Blue No. 1—Brilliant Blue FCF (E133), FD&C Blue No. 2—Indigotine (E132), FD&C Green No. 3—Fast Green FCF (E143), FD&C Red No. 40—Allura Red AC (E129), FD&C Red No. 3—erythrosine (E127), FD&C Yellow No. 5—tartrazine (E102), and FD&C Yellow No. 6—Sunset Yellow FCF (E110), and natural food colorants such as carmine (E120), enocianin (E163), black carrot (E163), paprika (E160c), annatto (E160b), beta carotene (E160a), lutein (E161b), riboflavin (E101), curcumin (E100), copper chlorophyllin (E141), chlorophyll (E140), caramel (E150), and extracts of foodstuffs such as elderberry, aronia, grape, beetroot, carrot, turmeric (tumeric) root, spinach, stinging nettle and burnt sugar (caramelized sugar).

The term “preservative”, as used herein, describes a synthetic or natural food additive substance that is added to food products, pharmaceuticals and the likes in order to prevent or retard chemical and biochemical decomposition of the product by oxygen, moisture and/or microbes. Exemplary anti-microbial preservatives include calcium propionate, sodium nitrate, sodium nitrite, sulfites (sulfur dioxide, sodium bisulfite, potassium hydrogen sulfite, etc.) and disodium EDTA, sodium benzoate, potassium sorbate. Natural substances that retard microorganisms growth include lactic acid, salt, sugar, vinegar and water binding natural foodstuffs such as fibers, starches and other substances that are lowering the water activity (Aw) of the foods to below the growth limits that are typical to bacteria, yeasts and molds.

Exemplary antioxidant preservatives include butylated hydroxyanisole (BHA) and butylated hydroxytoluene (BHT). Natural antioxidants include herbal extracts such as rosemary and oregano, and vitamins such as Vitamin E and Vitamin C (ascorbic acid)

The phrase “moisture stabilizing agent” or humectant, as used herein, describe a hygroscopic food additive substance. Humectants are molecules which typically exhibit several hydrophilic groups, such hydroxyl, amine and carboxyl groups, as well as esterified forms thereof. These groups possess the capacity to form hydrogen bonds with water molecules and thereby affix water in the food product they are added to. Exemplary humectants include, without limitation, glycerine, propylene glycol (E 1520), glyceryl triacetate (E1518), polyols, sorbitol (E420), xylitol, maltitol (E965), polymeric polyols, polydextrose (E1200), natural extracts such as quillaia (E999), lactic acid and urea.

The phrase “foaming agent”, as used herein, describe a food additive surfactant, which when present in small amounts, facilitates the formation of a foam, or enhances its colloidal stability by inhibiting the coalescence of bubbles. Exemplary foaming agents include, without limitation, sodium laureth/lauryl sulfate (SLS), sodium lauryl ether sulfate (SLES) and ammonium lauryl sulfate (ALS).

The phrase “antifoaming agent”, as used herein, describes a food additive substance that inhibits the formation of foam and curbs effusion or effervescence in food products. An exemplary antifoaming agent is polydimethylsiloxane.

As discussed hereinabove, a combination of several gelling agents can endow the composition with a wide variety of desired properties, hence, according to some embodiments, the honey-based composition may contain an additional gelling agent at a concentration ranging from about 0.001 to about 1 percent by weight of the total weight of the composition.

Non-limiting examples of additional gelling agents include thermo-reversible gelling agents, irreversible gelling agents, slow-setting gelling agents, rapid-setting gelling agents, arabinoxylan, cellulose, carboxymethylcellulose, curdlan, gellan gum (E418), guar gum (E412), gum arabic (E414), starch, xanthan gum (E415), alginic acid (E400), sodium alginate (E401), potassium alginate (E402), ammonium alginate (E403), calcium alginate (E404), agar, agarose (E406), locust bean gum (E410), gelatin (E441) and any combination thereof.

Aeration is a process by which bubbles of gas are produced in a liquid, such that when the liquid is setting into a solid or a semi-solid, the bubbles endow the solid with a foam-like structure. The addition of an aeration agent to the honey-based composition, according to some embodiments, endows the composition with an aerated consistency which is an optional desired characteristic of many food products. An aerated honey-based composition is softer and lighter, giving a pleasant mouth-feel and increases the mastication sensation as well as the dissolvability of the final product.

According to some embodiments, the aeration agent can be ammonium bicarbonate (E503) and/or sodium bicarbonate (E500), and according to some embodiments, these aeration agents are added to the honey-based composition at a concentration which ranges from 0.01 to 0.05 percent by weight of the total weight of the composition.

Other means of aeration may include bubbling of gas directly into the liquid formulation, applying high pressure of a gas to the liquid formulation or introducing other gas-forming agents into the formulation in its liquid, pre-gel-setting stage.

According to some embodiments, the honey-based composition contains solid and insoluble food ingredients which add to the taste, consistency and nutritional value of the final product.

Such food ingredients are preferably made from natural ingredients, and, further preferably, are utilized within the compositions described herein in such a form that preserves their natural nutritious value.

In some embodiments, the term “insoluble” describes ingredients which are not dissolved in the composition, neither is aqueous media.

Exemplary solid and insoluble ingredients include, without limitation, whole, chopped, natural, roasted, fried and/or dried nuts, whole, chopped, natural, malted, puffed, rolled and/or roasted, cereals and/or grains, as well as pieces of fresh, partially dehydrated and dried fruits, both whole or chopped.

The presence of insoluble ingredients calls for the use of suitable gelling agents which can set relatively fast so as to prevent subsiding of the solid substances, as discussed above.

Any of the agents, components and ingredients present in the compositions described herein is preferably considered as safe for human consumption and/or as edible.

As discussed herein, a wide variety of honey-based compositions having different properties and uses can be obtained by a particular selection of gelling agents, emulsifiers and thickening agents as well as relative content ratio therebetween and other ingredients.

While reducing the present invention to practice, the inventors have found that combinations of kappa carrageenans at concentrations that range from 1.3% to 1.5% of the total weight of the composition, and high methoxy (high ester)/slow setting pectins at a concentration range of 0.5% to 0.6%, form thermo-reversible gels at pH levels of 3.6 to 4.0 and high sugars concentrations of 76% to 82% of the weight of the composition, provide compositions that exhibit unique and desirable properties due to the partial instability at the acidic pH range (3.6 to 4.0) of carrageenan-based gels and of high methoxyl/slow set pectins, which typically form gels at pH levels of 3.3 to 3.5.

Hence, according to embodiments of the present invention, there is provided a honey-based composition, which is designed to possess the properties of softness, spreadability and rapid dissolution in hot aqueous media.

The composition, according to these embodiments, includes a higher content of an emulsifier and suitable additional gelling agent which can form soft and spreadable gels. Hence, according to some embodiments, a honey-based composition includes:

natural honey at a concentration ranging from 40 to 85 percent by weight of the total weight of the composition;

the thermo-reversible gelling agent kappa-carrageenan at a concentration ranging from 0.6 to 1.5 percent by weight of the total weight of the composition;

another thermo-reversible gelling agent at a concentration ranging from 0.1 to 0.5 percent by weight of the total weight of the composition;

a slow-setting pectin at a concentration ranging from 0.4 to 1.5 percent by weight of the total weight of the composition;

an acidic buffer at a concentration ranging from 0.5 to 2 percent by weight of the total weight of the composition; and

an emulsifier at a concentration ranging from 0.4 to 1.0 percent by weight of the total weight of the composition.

As designed and desired, such honey-based composition has the consistency of jelly, namely it is soft, spreadable and readily miscible in water, being capable of dissolving in hot aqueous media in 20-40 seconds, as measured for a 12 grams sample in 100 ml of hot aqueous media (e.g., at a temperature ranging from 70° C. to 95° C.) using a swivel motion (mimicking manual swirling of a cup of hot beverage with a tea-spoon).

Beside the use of relatively high content of the emulsifier, the desired properties of this type of honey-based composition are further enhanced by the use of an additional gelling agent. An exemplary additional gelling agent is low-acyl gellan gum.

Gellan gum (E418, see Scheme 4 below) is a bacterial exopolysaccharide, prepared commercially by aerobic submerged fermentation from Sphingomonas elodea (previously called Pseudomonas elodea).

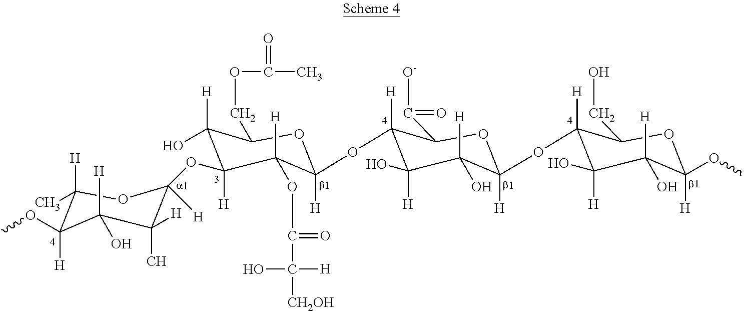

Gellan gum is a linear tetrasaccharide→4)-L-rhamnopyranosyl-(α-1→3)-D-glucopyranosyl-(β-1→4)-D-glucuronopyranosyl-(β-1→4)-D-glucopyranosyl-(β-1→ with O(2) L-glyceryl and O(6) acetyl substituents on the 3-linked glucose. It has high molecular weight, consisting of about 50,000 residues and is normally de-esterified by alkali treatment before use in food.

The functionality and application of gellan gum depends on the degree of acylation and the ions present in the composition. High acylated variants of gellan form soft, elastic, transparent and flexible gels. Low- or de-acylated variants form hard, non-elastic and brittle gels. A gellan gum solution may invisibly hold particles in suspension but, unlike other gelling agents, without significantly increasing the solution's viscosity. As firm but brittle gels, they crumble in the mouth to cleverly mimic the “melting in the mouth” sensation with the release of water and associated flavors from the weak gel network.

Gellan gum exhibits a gel-sol transition at about 50° C., depending on the concentration and presence of ions. Gellan gum is particularly useful in forming thermo-reversible gels in the presence of cations at low concentrations (0.005-0.1% w/w).

All other optional and suitable characteristics and ingredients of the honey-based compositions according to the embodiments presented hereinabove, such as the use of an additional sugar source, an acidulant buffer, the type of emulsifier, and other additional ingredients are as described herein.

The honey-based composition according to these embodiments can be characterized by a water activity that ranges from 0.6 to 0.7.

Further according to embodiments of the invention, there is provided a honey-based product, honey-based food product in particular, which comprises the honey-based composition that possesses the properties of softness, spreadability and rapid dissolution in hot aqueous media, as described hereinabove.

Such a product is a spoonable product.

The term “spoonable”, as used herein, describes a mechanical property of a semi-solid substance, such as a soft gel, which means that a portion thereof can be picked up easily from a bulk thereof by a human holding a spoon (e.g., teaspoon) or a similar object. The reference to ease of use refers not only to the physical force at which is required to perform this action (which is the commonly known reference to spoonability in the art), but also to the effect of the action of spooning the substance in terms of adhesion, flowability and release of the substance from the spoon. In other words, according to some embodiments of the present invention, the term “spoonable” refers to a honey-based product that, in sharp contrast to natural honey, can be picked up with a spoon or a similar object without having to address the consequences of the high viscosity of natural honey and its tendency to form strings and drips, and then unload the spoon from the product without having to address the consequences of the high adhesiveness of natural honey and its tendency to stick to the surface of the spoon.

Such spoonable honey-based products can be utilized as sweeteners, spreads, and in any other application in which liquid honey is utilized, while avoiding the inconvenience associated with common honey-based products.

Exemplary honey-based compositions of this type and spoonable products made therefrom are described in Example 2 in the Examples section that follows.

Spoonable honey-based products of the present embodiments can be packaged in a packaging material, and labelled accordingly, for example, as a spoonable product, a spread or a sweetener.

A suitable packaging material for spoonable honey-based products may be any container that can be sealed and contain a semi-liquid or liquid substance while preserving its water content and preventing spoilage by, for example, drying, oxidation or contamination for at least the time of expiration of the product, as determined by the producer of the product.

Exemplary suitable containers for spoonable products include rigid jars and bottles, squeezable jars and bottles, bags, tubes, cups and the likes.

The container can be made from one or more materials such as glass, alumina, plastic and the like.

The container may be a modified atmosphere package, which can serve to exclude contaminants and gases, and prevent drying of its content.

The phrase “modified atmosphere package” or MAP, as used herein, describes a type of package which is typically, but not necessarily, used to contain products that are sensitive to one or more environmental elements found in the ambient atmosphere, such as oxygen, humidity and combinations thereof. In order to prolong the shelf-life of such sensitive products, including food, drugs and other products for consumption, the products are contained in MAPs which are atmosphere-impervious sealed packages, that are filled with an alternative inert atmosphere, such as dry nitrogen, argon and the likes or are sealed under vacuum. The effectiveness of a MAP depends greatly on its imperviousness to both the inner and the outer atmospheres.

According to embodiments of the present invention, a MAP can be filled with oxygen-free atmosphere or a low oxygen atmosphere relative to ambient oxygen levels (less than 20%), both of which are suitable for some honey-based products that may deteriorate in high oxygen levels.

According to some embodiments of the present invention, the MAP is filled with any atmosphere which is meant to preserve the product therein, in terms of moisture (humidity), oxygen, microorganisms and any other elements commonly found in ambient atmosphere which can harm the product.

According to some embodiments, the MAP is filled with ambient atmosphere, and the packaging is meant to preserve that atmosphere for an extended period of time. According to other embodiments, the MAP is substantially evacuated from any atmosphere, as in the case of vacuum packaging, and the MAP is meant to exclude all atmosphere including oxygen.

Non-limiting examples of MAP material which are suitable for use in the context of the present embodiments considering characteristics such as gas permeability, water permeability, mechanical and chemical properties and optical transparency, include glass, low density polyethylene (LDPE), polyvinyl chloride (PVC), polypropylene (PP), polyethylene terephthalate (PET), ethylene-vinyl acetate (EVA), oriented polypropylene (OPP) and the like.

MAP shape and forms include, without limitation, films of various thicknesses and number of layers, capped containers, cans, jars and bottles, sealable bags, pouches, sachets, tubes and the like.

According to other embodiments of the invention, there is provided another type of honey-based composition, which is designed suitable for producing a handleable honey-based product, as defined hereinunder.

The composition, according to these embodiments, comprises a relatively low amount of the emulsifier, which ranges from 0.2 to 0.4 percent by weight of the total weight of the composition. Distinctly from the jelly-like spreadable composition described hereinabove, the composition according to these embodiments preferably does not comprise an additional gelling agent for forming a soft and spreadable gel.

Other components of the composition according to these embodiments are as described herein.

The compositions according to these embodiments are also designed as being readily miscible in water. Thus, this type of composition is capable of dissolving in hot aqueous media in 30-60 seconds, as measured for a single 12 grams cuboid piece sample of the composition placed in 100 ml of hot aqueous media and dissolved using a swivel motion (mimicking manual swirling of a cup of hot beverage with a tea-spoon). The rate of dissolution is highly dependent on the surface area of the sample, hence the smaller the size of the tested pieces is, the faster the rate of dissolution would be.

Thus, these compositions include a slow setting pectin, and can further include an acidulant, additional sugar source, flavoring and odoriferous agents, colorants, preservatives, moisture stabilizing, foaming agent and antifoaming agents, as described herein.

The composition can further comprise an aeration agent, as discussed hereinabove.

A composition according to these embodiments thus generally comprises:

a natural honey at a concentration ranging from 40 to 85 percents by weight of the total weight of the composition;

kappa-carrageenan at a concentration ranging from 0.6 to 1.5 percents by weight of the total weight of the composition;

a slow-setting pectin at a concentration ranging from 0.4 to 1.5 percents by weight of the total weight of the composition;

an acidic buffer at a concentration ranging from 0.5 to 2 percents by weight of the total weight of the composition; and

an emulsifier at a concentration ranging from 0.2 to 0.4 percent by weight of the total weight of the composition.

The composition according to these embodiments can also be characterized by springiness, ranging from 50 percents to 70 percents, and by cohesiveness, ranging from 0.2 to 0.7.

The composition according to these embodiments can also be characterized by a water activity that ranges from 0.6 to 0.7.

In some embodiments, the composition according to these embodiments further comprises a flavoring agent such as an extract or juice of a fruit, vegetable and/or herb. Such compositions can be used for producing handleable products such as candies or bars.

In exemplary embodiments, the flavoring agent is an extract (or concentrate of an extract or juice) of a highly nutritious herb, fruit or vegetable. Exemplary extracts include extracts (or juice concentrates) of e.g., orange, carrot and/or pomegranate, which include high content of antioxidants and other nutritious components.

In some embodiments, the concentration of such flavoring agents ranges from 1 to 15 percents by weight, of the total weight of the composition.

Such compositions can thus be utilized for producing honey-based products with high nutritious value, which can also serve as nutrition additives (nutraceuticals).

Further according to embodiments of the invention there is provided a honey-based product, honey-based food product in particular, which comprises the suitable honey-based composition described hereinabove. Such a product has a form of a handleable honey-based product.

Related to spoonable, the term “handleable”, as used herein, describes a mechanical property of a semi-solid substance, such as a gel, which means that relatively small pieces thereof, weighing for example from 0.2 grams to 20 grams each, are capable of being handled, or in other words, can be picked up by hand using bare fingers substantially without having the substance stick to the fingers or run therethrough. In relevance to some embodiments presented herein, a handleable semi-solid honey-based product is such that can be picked up by hand and thereafter be released from the fingers substantially without having to address the consequences of the high viscosity and/or the high adhesiveness of natural honey and its tendency to stick to the fingers.

Such a property is highly desired with household sweeteners, and is mostly encountered with white or brown sugar lumps or cubes. In exemplary embodiments of the invention, the provision of such handleable products allows honey to be used much like sugar, in the form of handleable chucks or lumps, oftentimes generalized as “cubes”.

The shape and morphology of the handleable products presented herein can be determined during the manufacturing process of the composition, described hereinbelow, while the composition is still hot and liquid, by pouring it into a mold, or after the cooling and solidification process, by cutting or breaking a large gel block into smaller shaped or amorphous pieces. When broken or crushed from a block, the morphology of the handleable product can exhibit a random morphology such as, for example, the morphology of a prill, a nugget, a pellet, a flake or a granule. When punched out of a block using a punching pattern, or when poured into a mold, the handleable products can exhibit an ordered, premeditated morphology such as, for example, the shape of a cube, a ball, a pill, a caplet, a tablet, a wafer, a briquette, a puck or/and a block. When cut or molded into a reproducible shape, the shape of the handleable products may be a box, a sphere, a cube, an ellipsoid, a cylinder, a bar, a cone, a pyramid, a frustum, a prism, a torus, a shape similar to same, or any other pre-planned three dimensional shape.

Once cut, molded or otherwise shaped, the handleable honey-based products can be coated with a suitable edible powder so as to render it more suitable for touch and to prevent sticking of the individual pieces to one another or to the packaging material. An exemplary suitable coating powder is natural cellulose fibers.

Exemplary compositions and handleable products made therefrom are described in Examples 1, 3 and 5 in the Examples section that follows.

According to some embodiments of the invention, the handleable honey-based products described herein can be packaged in a packaging material, and labelled accordingly as a handleable product such as a candy or a sweetener. The packaging may be for each individual piece of the handleable honey-based products, or for a group of pieces, all according to the intended use, piece size and preference.

A suitable packaging material for handleable honey-based products may be any container that can be sealed and contain a semi-solid or solid food item while preserving its water content and preventing spoilage by, for example, drying, oxidation or contamination for at least the time of expiration of the product, as determined by the producer of the product.

Exemplary suitable container for handleable products include hard and wide-mouth jars, cups, boxes, wraps, blister-packs and the likes, made of, for examples, glass, plastic, paper, cellophane paper, metal, and the like.

The container for a handleable honey-based product of the present embodiments may be a MAP, as defined hereinabove.

According to other embodiments of the invention there is provided yet another type of honey-based composition, which is designed suitable for producing a honey-based snack bar product, as described hereinunder.

Such a composition typically comprises:

natural honey at a concentration ranging from 40 to 85 percent by weight of the total weight of the composition;

a food ingredient, as defined herein, at a content ranging from 0.01 to 30 percents by weight of the total weight of the composition;

kappa-carrageenan at a concentration ranging from 0.6 to 1.5 percent by weight of the total weight of the composition;

a rapid-setting pectin at a concentration ranging from 0.4 to 1.5 percent by weight of the total weight of the composition;

a thickening agent at a concentration ranging from 0.01 to 0.1 percent by weight of the total weight of the composition;

an acidic buffer at a concentration ranging from 0.5 to 2 percent by weight of the total weight of the composition; and

an emulsifier at a concentration ranging from 0.2 to 0.4 percent by weight of the total weight of the composition.

The special feature of the composition according to these embodiments is the incorporation of food ingredients, as these are described hereinabove. Inherently, although the formulation of such snack bar products is not designed specifically for rapid dissolution in hot aqueous media as in the cases of the compositions designed to form spoonable and handleable honey-based products presented herein, it has been found that this formulation, and the entailed solubility thereof, is desirable as it endows a honey-based product produced from this composition with a pleasant mouth feel.

The composition according to these embodiments is further characterized as including a rapid set gelling agent, which is required to set fast in order to prevent the sinking (subsiding) of insoluble food ingredients. Hence, according to some embodiments, the rapid setting gelling agent is a rapid-setting pectin, such as a rapid setting high ester (methoxy) pectin, as discussed hereinabove.

The composition according to these embodiments is further characterized as comprising a thickening agent at a content ratio of 0.01 to 0.1 percent by weight of the total weight of the product.

The phrase “thickening agent”, as used herein, describes a class of nearly flavorless food additives which is partially overlapping with the class referred to herein as “gelling agents”. A thickening agent or thickeners, is added to food products in order to alter their consistency and texture, and typically heighten their viscosity and rendering the food product more viscid. Typically the thickening agent is based on carbohydrates such as polysaccharides, starches, and vegetable and fruit gums; or based on proteins, such as collagen and gelatin. Exemplary vegetable-based thickener include, without limitations, arrowroot, cornstarch, katakuri starch, potato starch, sago, tapioca, alginin, guar gum, locust bean gum, and xanthan gum, agar and carrageenan, and exemplary protein-based thickeners include, without limitations, collagen, egg whites, furcellaran and gelatin.

An exemplary thickening agent, suitable for use in the honey-based compositions described herein, is xanthan gum.

Xanthan gum (E415) is a microbial desiccation-resistant polymer prepared commercially by aerobic submerged fermentation from Xanthomonas campestris, and is naturally produced to affix bacterial cells to glossy surfaces of plants.

Xanthan gum (see, Scheme 5 below) is an anionic polyelectrolyte with a β-(1→4)-D-glucopyranose glucan (as cellulose) backbone with side chains of -(3→1)-α-linked D-mannopyranose-(2→1)-β-D-glucuronic acid-(4→1)-β-D-mannopyranose on alternating residues.

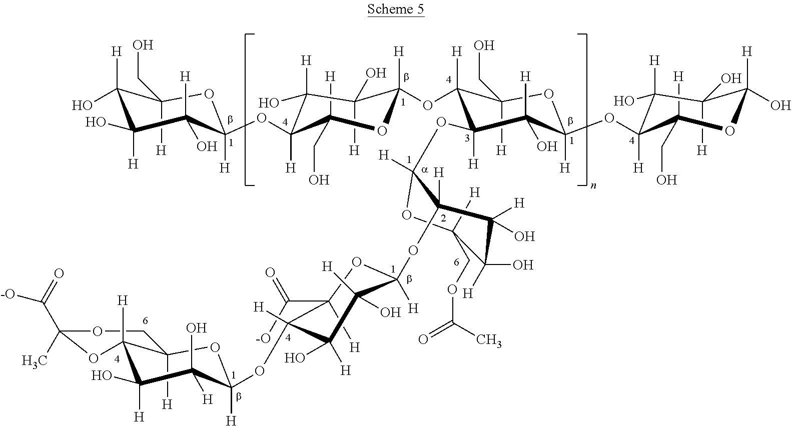

Xanthan gum is relatively homogeneous and reproducible as it is produced by fermentation (the gum is less polydispersed than most hydrocolloids), with each molecule consists of about 7000 pentamers. The glucan backbone is protected by the side chains which lie alongside, making it relatively stable to acids, alkalis and enzymes (this is required since preparations can contain cellulase), and the use of different strains or fermentation conditions may give rise to differing degrees of acetylation and pyruvylation, which moderates the functionality.

The conversion between an ordered double helical conformation and a single more-flexible extended chain may take place over hours of annealing (equilibrating) at between 40° C. and 80° C., and the weakly bound network which forms is highly pseudoplastic. Hence, xanthan gum is relatively unaffected by ionic strength, pH (1-13), shear or temperature, and is mainly considered to be non-gelling and used for the control of viscosity due to the tenuous associations endowing it with weak-gel shear-thinning properties, encouraging its use as thickener, stabilizer, emulsifier and foaming agent. The consistent water holding ability may also be used for the control of syneresis and to retard ice recrystallization (ice crystal growth) in freeze-thaw situations. Its most important property being its very prominent low-shear viscosity coupled with its strongly shear-thinning character. The relatively low viscosity at high shear means that it is easy to mix, pour and swallow but its high viscosity at low shear gives good suspension and coating properties and lends stability to colloidal suspensions.

The honey-based composition according to these embodiments can also be characterized by springiness that ranges from 50 percents to 70 percents, and by cohesiveness that ranges from 0.2 to 0.7, however, these properties may be altered significantly depending of the amount and type of food ingredient and the presence of the thickening agent.

The honey-based composition according to these embodiments can also be characterized by a water activity that ranges from 0.65 to 0.7.

Similar to the other compositions described herein, the compositions according to these embodiments can further contain an acidulant, additional sugar source, flavoring and odoriferous agents, colorants, preservatives, moisture stabilizing, foaming agent and antifoaming agents, as described herein. In some embodiments, the composition further comprises an aeration agent, as discussed above.

Further according to embodiments of the invention there is provided a honey-based product, a honey-based food product in particular, which comprises the honey-based composition described hereinabove and is being a honey-based snack bar product.

Similar to the handleable product, the snack bar honey-based products can be shaped by molding and/or cutting to afford any desirable shape, as presented hereinabove.

Once cut, molded or otherwise shaped, the snack bar honey-based products can be coated with a suitable edible powder so as to render it more suitable for touch and to prevent sticking of the individual pieces to one another or to the packaging material. An exemplary suitable coating powder is natural cellulose fibers.

Similar to the handleable products, the snack bar honey-based products of the present embodiments can be packaged in a packaging material suitable for such products, and labelled accordingly as a candy or a snack bar.

According to another aspect of the present invention, there is provided a process of manufacturing the honey-based compositions presented herein. The general process includes the addition of some of the ingredients at a one order or another, mostly with respect to their physical state, namely solids, powdered, solubilized, pre-heated and the likes. The process is generally effected by:

heating the honey to about 60° C. while stirring the honey in a suitable vessel;

mixing a dry and powdered carrageenan into the heated and stirred honey;

adding a pre-heated aqueous solution of the acidic buffer thereto;

admixing a dry mixture containing all the other dry and/or liquid ingredients, such as the pectin, the additional sugar source, the emulsifier, the optional and additional gelling agent(s), the optional additional food ingredients, and the optional thickening agents, to thereby obtain a hot honey-based liquid formulation; and

reheating and stirring this hot honey-based liquid formulation to 90-95° C. in order to obtain homogeneity and full dissolution of all soluble ingredients, and also to achieve a desired degree Brix.

Subsequently, the hot honey-based liquid formulation is allowed to cool to room temperature, so as to allow the gelling agent(s) to form the gel, and thereby obtain the honey-based composition.

The process may further include, prior to cooling the hot liquid formulation, pouring the hot formulation into a mold having a desired shape.

The process may include, prior to pouring the hot liquid formulation, adding any additional ingredient such as an additional gelling agent, an aeration agent, a food ingredient, a flavoring agent, a thickening agent, an odoriferous agent, a colorant, a preservative, a moisture stabilizing agent, a foaming agent, an antifoaming agent and the likes, and any combination thereof.

In the case of the handleable and/or the snack bar honey-based compositions, the process may also include, subsequent to the cooling and molding stages, coating the honey-based composition with, e.g., natural cellulose fibers. Such coating endows the semi-solid compositions silky smooth hand- and mouth feel and also retards clumping.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

It is noted herein that apart from providing honey-based compositions with unique characteristics, and honey-based products produced therefrom, which are easy and convenient for use, the compositions and products according to some embodiments of the invention are further advantageously characterized as being composed of natural substances and/or of substances with high nutritious value.

It is further noted herein that physical, chemical and/or mechanical characteristics of the compositions and products described herein, as well as other properties such as dissolvability, taste, texture, viscosity and the like, can be further manipulated by selecting a suitable ingredient among the ingredients described herein, at a suitable concentration, so as to achieve the desired properties.

Various embodiments and aspects of the present invention as delineated hereinabove and as claimed in the claims section below find experimental support in the following examples.

### EXAMPLES

Reference is now made to the following examples, which together with the above descriptions, illustrate some embodiments of the invention in a non limiting fashion.

### Materials and Methods

Honey from sources such as citrus blossom, wild flowers, Ziziphus (Shiziphus) blossom, avocado blossom and the likes, was purchased from the Ein-Harod apiary, Israel.

Rapid-set high ester pectin (RSHEP), extracted from citrus peels, 150 USA-SAG, type B, standardized with sucrose, was purchased from CP Kelco, USA.

Slow-set high ester pectin (SSHEP), extracted from citrus peels, 150 USA-SAG, type D, standardized with sucrose, was purchased from CP Kelco, USA.

Low ester pectin (LEP), extracted from citrus peels, type LM-5-CS, standardized with sucrose, was purchased from CP Kelco, USA.

Partly amidated low ester pectin (PALEP), extracted from citrus peels, type LM-104 AS-FS, standardized with sucrose, was purchased from CP Kelco, USA.

Kappa-carrageenan, type X-304-03, standardized with sucrose (referred to herein for brevity as carrageenan), was purchased from CP Kelco, USA.

Xanthan gum, type Keltrol F, was purchased from CP Kelco, USA.

Low-acyl gellan gum, type Kelcogel F, was purchased from CP Kelco, USA.

Trisodium citrate dihydrate and anhydrous citric acid were purchased from Gadot Biochemichal Industries, Israel.

Sucrose-fatty acid ester, type SP70, used as an emulsifying agent, was purchased from Sisterna B.V., Holland.

Sodium and ammonium bicarbonates were purchased from Rhone-Poulenc, France.

Cellulose powders, type Vitacel L600/L600-30, were purchased from J. Rettenmaier and Sohne GMBH, Germany.

Fructose powder was purchased from Galam Ltd, Israel.

Orange concentrate, 62° Bx, was purchased from Milos, Israel.

Pomegranate concentrate, 65° Bx, purchased from Bakukonsery JCS, Azerbaijan.

Calcium Lactate, 5H₂O, from Gadot Biochemical Industries, Israel.

Carrot bioactive extract, 65±5° Bx, purchased from GNT international B.V., Holland.

Methods and Apparatus:

A 53000 C model refractometer by T. R. Turoni SRL, Forly, Italy, was used for determining the degrees Brix in the range of 0-32° Bx, and a 53023 model refractometer by the same maker was used to determine the Brix at the range of 30-65° Bx.

Water activity measuring device (“Pawkit”—Decagon, USA).

pH meter with temperature compensation (“Hanna” model HI 83141, Israel).

Variable speed stirrer with RPM Display (“Boeco” model 05-D-20 Boeckel and Co., GMBH, Germany).

Texture profile Analysis (“Texture Analyzer”, TA 500, Lloyd Instruments Ltd., U.K.).

Standard laboratory equipment which was used included a stainless steel vessel with heating elements, a rotor-stator type stirrer-homogenizer, weighing scales and thermometers.

General Formulation:

The honey content in the formulations presented herein can range from 40%, in cases where honey is not the only source of carbohydrates (sugars), and up to 85%, in cases where honey is the only source of sugars in the formulation.

In general, in order to achieve an all honey” formulation, the manufacturing process includes a procedure in which the pectin powder, and similarly all other optional powdered ingredients such as citric acid, trisodium, citrate and sucrose ester, is hydrated separately in hot water.

The preparation processes provided below are simple and easy to apply, namely all the powdered/dry ingredients, except the carrageenan, are pre-mixed with water and other pre-solubilized ingredients and then added directly to the hot honey-carrageenan mixture, as detailed below.

Assuming that all ingredients except water are non-volatile, the yield of the preparation process can be calculated based on the total weight of finished composition divided by the total weight of formulation blend. This simple calculation should allow determining the amount of evaporated water, thereby facilitating the determination of percentage increase of all other ingredients, including the final honey content of the composition.

Texture Profile Analysis:

Numerical measurements of textural and physico-mechanical properties of exemplary solid honey-based products according to some embodiments of the invention were acquired by cyclic compression tests and stress-relaxation tests using the following apparatus and method:

The texture profile analysis (TPA) of the samples was performed on a texture analyzer device (TA500 by Lloyd Instruments Ltd., Fareham, Hampshire, UK), using a cylindrical probe (10 mm in diameter), head-speed of 100 mm/minute and cell load of 10 N and 100 N.

Cuboid shaped samples of exemplary solid honey-based products according to some embodiments of the invention were cut to the dimensions of 17 mm height, 32 mm length and 28 mm width.

The samples were exposed to pressure (compressed) in two cycles at a rate of 100 mm/minute so as to obtain a deformation of 65% of their original height, namely pressed to a height of 11 mm.

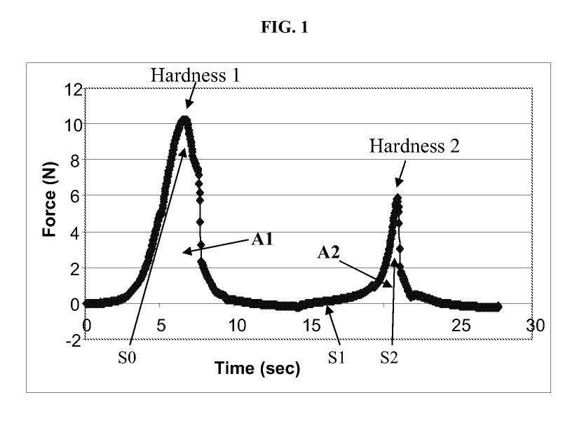

FIG. 1 presents a typical plot of applied force as a function of time, as obtained while exposing a sample of a solid honey-based product, according to some embodiments of the invention, to two compressing presses, using a texture analyzer device, wherein the compression cycles are marked as “Hardness 1” for the first compression cycle and “Hardness 2” for the second compression cycle.

The overall hardness of the samples was estimated from the response of the sample to two presses which are expressed by the force needed to achieve a reduction of 65% in the sample's height. The first press, marked as “Hardness 1” in FIG. 1, is indicative of the original structural strength of the sample, and the second press, marked as “Hardness 2” in FIG. 1, is indicative of the elasticity of the sample, or its capacity to regain its original structure.

The overall cohesiveness of the samples can be estimated by calculating the ratio between the energy which is required to compress the sample twice, and the energy which is required to compress the sample once. This parameter is estimated from the ratio between the areas under the peaks in the plot of FIG. 1, namely A2 which is the area under the peak marked as “Hardness 2”, divided by A1 which is the area under the peak marked as “Hardness 1”. This unitless parameter, or dimensionless quantity, is indicative of the capacity of the product to stick together and stay intact, since if most or some of the sample is crushed during or as a result of the first compression cycle, less energy is applied at the second compression cycle.

The overall springiness of the samples can be estimated from difference in the height of the sample at the peak of the second compression cycle (marked as S2 in FIG. 1) and after the first compression cycle (marked as S1 in FIG. 1), divided by the original height of the sample, denoted S0 in FIG. 1. Hence, the springiness is evaluated as S2-S1/S0, and is expressed in percents.

### Example 1

### Handleable and Molded Honey-Based Products

### Preparation—General Procedure:

The following is a general procedure for preparing handleable honey-based products exhibiting instant-high solubility in hot beverages. The products can be molded to take the form of bits, chunks, dices, balls, and the likes, which are convenient for everyday household use, manual handling and fingering being non-sticky. These honey-based handleable honey-based products are formulated for rapid dissolution in hot aqueous media such as hot water and other hot beverages (teas, infusions, coffee, chocolate drinks, fruit based hot beverages such as ciders, hot punch and the likes). The handleable honey-based products can be used as a candy or as a sweetener in a similar manner as sugar lumps. In some embodiments, the handleable honey-based products can be prepared with flavoring agents and substances such as natural herbs and fruit juices and extracts, such as lemon, apple, mint and the likes.

Honey (40-85 parts by weight) is stirred and heated to 60° C. in a stainless steel vessel. Carrageenan powder (0.4-1.5 parts by weight) is added to the heated and stirred honey, and thereafter an aqueous solution of trisodium citrate (0.3-0.6 parts by weight), one quarter of the citric acid (50% aqueous solution, 0.6-1.4 parts by weight) and water (12.0-14.00 parts by weight) is preheated and added thereto. Thereafter, a dry pre-blended mix containing an additional sugar, such as fructose, sucrose, brown cane sugar and the likes (0-15 parts by weight), pectin (0.4-1.5 parts by weight) and sucrose fatty acids ester (0.1-0.35 parts by weight) used as an emulsifying agent, is added to the heated and stirred mixture, and the honey and gelling solution is heated to 90° C. Thereafter the remainder of the citric acid 50% solution is added, and the mixture is heated to 90-95° C. while stirring. The hot mixture is thereafter poured into a mold having a desired shape and allowed to cool to room temperature. Once hardened, the resulting semi-solid handleable honey-based gel bits are coated in natural cellulose fibers to prevent stickiness.

In some embodiments of this general procedure, water can be fully or partially replaced with fruit juice or a blend of fruit juices. The amount of sugars added by the fruit juices is then taken into consideration for adjusting the amount of other added sugars.

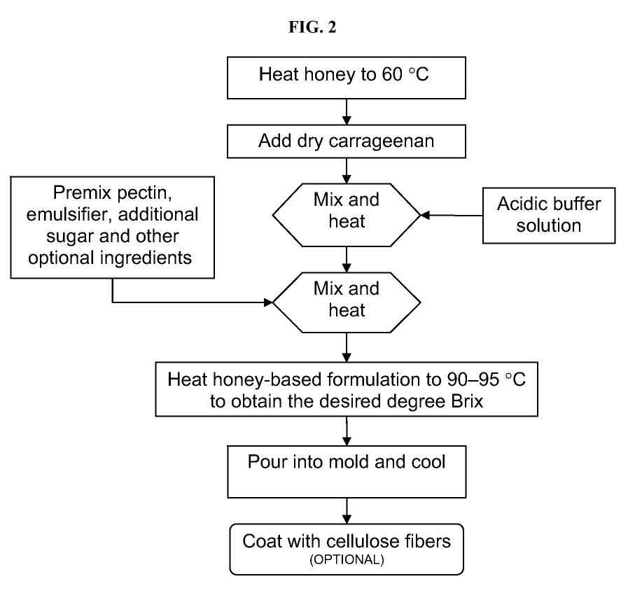

FIG. 2 is a flow-chart presenting an exemplary process of preparing the handleable and molded honey-based products according to some embodiments of the present invention.

Table 1 below presents an exemplary formulation for the above-described embodiment of honey-based compositions.

TABLE 1

| Ingredient | Content (%) |
|---|---|
| Natural honey | 65.70 |
| Fructose | 17.40 |
| Water | 13.10 |
| Pectin (slow set) | 1.10 |
| Carrageenan | 1.00 |
| Citric acid (50% aqueous | 1.00 |
| solution) | |
| Trisodium citrate | 0.40 |
| Sucrose ester (emulsifier) | 0.30 |

Solubility Assays:

The solubility of the handleable honey-based products was assayed visually by placing 12 grams of handleable honey-based bits (average diameter of 15 mm) in a 100 ml glass filled with water at 90° C. and stirring the content of the glass manually using a household teaspoon while measuring the time to complete dissolution of all visible bits. The amount of 12 grams of handleable honey-based bits is equivalent to 10 grams of sucrose in terms of perceived sweetness provided by 1 teaspoon of sucrose (common household sugar).

Table 2 below presents the results of the mechanical and aqueous dissolubility assays as measured for three exemplary samples of handleable honey-based products having different pectin type, prepared according to the general procedure and formulation presented hereinabove.

TABLE 2
Product Handleable honey-based products

| Sample number | 057A | 057B | 066 |
|---|---|---|---|
| Ingredients | Natural honey | | 65.7% |
| | Fructose | | 17.4% |
| | Water | | 13.1% |
| | Pectin | | 1.1% |
| | Carrageenan | | 1.0% |
| | Citric acid (50% aqueous | | 1.0% |
| | solution) | | |
| | Trisodium citrate | | 0.4% |
| | Sucrose ester (emulsifier) | | 0.3% |
| Pectin Type | Rapid set | Slow set | 40% rapid set |
| | | | 60% slow set |
| pH | 3.84 | 3.83 | 3.94 |
| Brix (° Bx, w/w) | 83.4 | 77.4 | 83.4 |
| Water activity (aw) | 0.66 | 0.67 | 0.66 |
| Texture: | | | |
| Organoleptic Evaluation | Firm | Less firm | Firm |
| Springiness | 64.30 | 64.6 | — |
| Cohesiveness | 0.355 | 0.62 | — |
| Hardness (1)* | 10.3 | 5.30 | — |
| Hardness (2)* | 5.91 | 3.67 | — |
| Time measured for complete | 45-47 sec. | 32-36 sec. | 65-70 sec. |
| visual dissolution in water | | | |
| (90° C.), stirred | | | |
| manually using a teaspoon | | | |
| Time measured for complete | 2 minutes | 2 minutes | 2 minutes and |
| visual dissolution in water | and 48 | and | 40 seconds |
| (90° C.), stirred | seconds | 30 seconds | |
| mechanically at 500 RPM | | | |

Table 3 below presents the results of the manual and mechanical dissolution assays performed with four 12 gram samples of handleable honey based products, having various pectin and carrageenan contents and varied water sources, namely untreated tap water and deionized water. The assays were performed in 100 ml of tap water at 90° C.

The tap water analysis is: total chlorides, 124 mg/liter; calcium, 29 mg/liter; magnesium, 18 mg/liter; potassium, 3 mg/liter; sodium 9 mg/liter; and the pH is 8.0.

TABLE 3

| Sample number | 071A | 071B | 071C | 071D |
|---|---|---|---|---|
| Ingredients: | | | | |
| Natural honey | 65.7 | 65.7 | 65.7 | 65.7 |
| Fructose | 17.4 | 17.4 | 17.4 | 17.4 |
| Deionized water (pH 7.4) | 13.1 | — | — | — |
| Tap water * | — | 13.1 | 13.1 | 13.1 |
| Pectin (slow set) | 1.1 | 1.1 | 0.6 | 0.8 |
| Carrageenan | 1.0 | 1.0 | 1.5 | 1.3 |
| Citric acid (50% aq. sol.) | 1.0 | 1.0 | 1.0 | 1.0 |
| Trisodium citrate | 0.4 | 0.4 | 0.4 | 0.4 |
| Sucrose ester (emulsifier) | 0.3 | 0.3 | 0.3 | 0.3 |
| pH | 3.58 | 3.59 | 3.78 | 3.83 |
| Brix (%, w/w) | 77.4 | 81.0 | 80.4 | 75.0 |
| Texture | Soft | Less firm | Firm | Less firm |
| Time measured for complete | 30-35 | 42-55 | 38-40 | 43-53 |
| dissolution of a 12 gram sample | seconds | seconds | seconds | seconds |
| in 100 ml of hot water (90° C.), | | | | |
| stirred manually, using a | | | | |
| teaspoon (swiveling motion) | | | | |
| Time measured for complete | 2 minutes | 2 minutes | 2 minutes | 2 minutes |
| dissolution of a 12 gram sample | and | and | and | and |
| in 100 ml of hot water (90° C.) | 25 seconds | 41 seconds | 30 seconds | 42 seconds |
| stirred mechanically at 500 rpm | | | | |
| (circular motion) | | | | |

The obtained data show that the pectin has a firming effect on the handleable hone-based gel, and further show that the effect of tap water, which contains calcium, is a firmer handleable honey-based gel. The solubility aptitude in aqueous media is similar for all samples.

### Example 2

### Spoonable, Soft and Spreadable Honey-Based Products

Preparation—General Procedure:

The following is a general procedure for preparing spoonable (jellied) honey-based products exhibiting instant-high solubility in hot beverages. The spoonable products are formulated to be soft and spreadable yet non-sticky, so as to have the consistency of jellied jam (jelly). Such spoonable honey-based products are convenient for everyday household use as a sweetener and sugar substitute, suitable for handling by a spoon or a teaspoon (“spoonable”), being semi-fluid yet non-sticky. In some embodiments, the spoonable honey-based products are prepared with flavoring agents and substances such as natural herbs and fruit juices and extracts and the likes.

Honey (40-85 parts by weight) is stirred and heated to 60° C. in a stainless steel vessel. Carrageenan powder (0.5-1.0 parts by weight) is added to the heated and stirred honey, and thereafter an aqueous solution of trisodium citrate (0.3-0.6 parts by weight), citric acid (50% aqueous solution, 0.2-0.3 parts by weight) and water (12.0-14.00 parts by weight) is preheated and added thereto followed by pectin (1.0-1.2 parts by weight). At this stage, the optional solution of natural flavoring agent(s) such as, for example, lemon flavor (0.05-0.3 parts by weight) is added to the mixture. Thereafter, a dry pre-blended mix containing a sugar, such as fructose, sucrose, brown cane sugar and the likes (10-25 parts by weight), gellan gum (0.1-0.5 parts by weight) and sucrose fatty acids ester (0.4-1.0 parts by weight) used as an emulsifying agent, is added to the heated and stirred mixture, and the honey and gelling solution is heated to 90-95° C. until all solids are dissolved or until a desired ° Bx is achieved (from about 76° Bx to about 82° Bx). The hot mixture is thereafter transferred into hot-fill containers, sealed and allowed to cool to room temperature.

Gellan gum is used in the preparation of the spoonable honey-based products according to embodiments of the present invention as a thermo-reversible gel in order to obtain a smooth and spreadable jellied type product.

In some embodiments of this general procedure, water can be fully or partially replaced with fruit juice or a blend of fruit juices. The amount of sugars added by the fruit juices is then taken into consideration for adjusting the amount of other added sugars.

Table 4 below provides an exemplary formulation for the above-described embodiment of jellied honey-based products. The solubility of the spoonable honey-based products was assayed visually as described above for the handleable honey-based bits. The results of the solubility assay conducted using the above formulations are presented in Table 4 below.

TABLE 4
Product Jellied, soft and spreadable honey-based products

| Sample number | | 058A | 058B | 067 |
|---|---|---|---|---|
| Ingredients | Natural honey | 62.70% | 65.40% | 65.40% |
| | Fructose | 20.90% | 17.44% | 17.44% |
| | Water | 12.86% | 13.18% | 13.10% |
| | Pectin (slow set) | 1.10% | 1.13% | 1.13% |
| | Carrageenan | 0.50% | 0.55% | 0.55% |
| | Citric acid (50% aq. | 0.96% | 1.00% | 1.00% |
| | sol.) | | | |
| | Trisodium citrate | 0.41% | 0.43% | 0.43% |
| | sucrose ester | 0.42% | 0.52% | 0.60% |
| | (emulsifier) | | | |
| | Gellan gum (low- | 0.16% | 0.35% | 0.35% |
| | acyl type) | | | |

| | | | |
|---|---|---|---|
| pH | 3.91 | 3.87 | 3.95 |
| Brix (° Bx, w/w) | 81.6 | 80.0 | 85.8 |
| Water activity (a_{w}) | 0.60 | — | 0.68 |
| Texture - Organoleptic Evaluation | Relatively | Relatively | Firm gel |
| | soft gel | soft gel | |
| Time measured for complete visual | 25-30 sec. | 22-24 sec. | 40-50 sec. |
| dissolution in water (90° C.), | | | |
| stirred manually using a teaspoon | | | |
| Time measured for complete visual | 40-41 Sec. | 42-51 Sec. | 50-60 Sec. |
| dissolution in water (90° C.), | | | |
| stirred mechanically at 500 RPM | | | |

### Example 3

### Handleable Honey-Based Products Exhibiting Aerated Texture

### Preparation—General Procedure:

The following is a general procedure for preparing solid honey-based bar-shaped products, which exhibit an aerated texture and pleasant mouth-feel. In some embodiments, these honey-based bars are prepared with natural herbs and fruit juices and extracts:

Honey (65.55 parts by weight) is preheated to 60° C. in a stainless steel vessel. The following ingredients are added to the heated honey, in the following order: Carrageenan powder (0.96-1.13 parts by weight), water (13.0-13.1 parts by weight); trisodium citrate (0.41-0.43 parts by weight) and citric Acid (50% solution, 0.96-1.00 parts by weight); pectin solution of the rapid set or the slow set type (1.13-1.14 parts by weight); concentrated solution of natural flavoring agent(s) (from about 0.05% to about 0.15%, as desired); sugar(s) such as fructose or brown cane sugar (17.37-17.47 parts by weight), xanthan (0.01-0.1 parts by weight); and a solution of sucrose fatty acids ester as emulsifying agent(s) (from about 0.2% to about 0.5%, or about 0.26 parts by weight).

Xanthan Gum is added to the formulation in order to increase the viscosity of the aerated mixture, thereby trapping the bubble of gas in the matrix of the slowly cooling and solidifying aerated liquid formulation.

The resulting mixture is stirred at a temperature of 90-95° C. until all solids are dissolved and/or until a certain ° Bx is achieved (from about 76° Bx to about 82° Bx). Thereafter, dry powdered ammonium carbonate or sodium bicarbonate (0.02-0.03 parts by weight) is added to the hot mixture, and the mixture is whipped and aerated to a desired volume using standard whipping equipment known in the art. The aerated mixture is then molded into bars or other desired shapes and air-cooled. The resulting aerated shapes are coated with natural cellulose fibers to prevent stickiness.

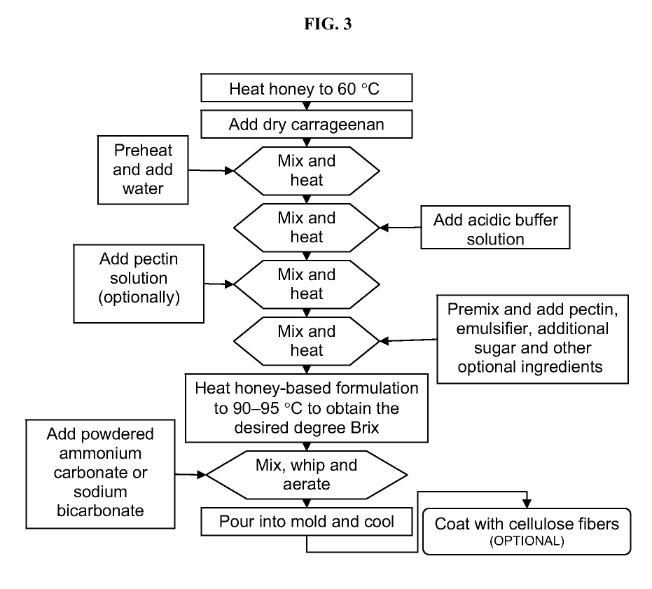

FIG. 3 is a flow-chart presenting an exemplary process of preparing the aerated handleable and molded honey-based products according to some embodiments of the present invention.

In some embodiments of this general procedure, water can be fully or partially replaced with fruit juice or a blend of fruit juices. The amount of sugars added by the fruit juices is then taken into consideration for adjusting the amount of other added sugars.

Table 5 below provides an exemplary formulation for the above-described embodiment of the solid honey-based and bar-shaped products.

TABLE 5
Product Solid and aerated honey-based bars

| Sample number | | 038 | 059B |
|---|---|---|---|
| Ingredients | Natural honey | 65.54% | 65.53% |
| | Water | 13.10% | 13.03% |
| | Fructose | 17.47% | 17.37% |
| | Carrageenan | 0.96% | 1.13% |
| | Pectin | 1.14% | 1.13% |
| | Citric acid (50% aq. sol.) | 1.00% | 1.00% |
| | Trisodium citrate | 0.44% | 0.43% |
| | Sucrose ester (emulsifier) | 0.26% | 0.26% |
| | Xanthan | 0.04% | 0.09% |
| | Ammonium Bicarbonate | 0.025% | 0.026% |

| | | |
|---|---|---|
| Pectin Type | Slow set | Rapid set |
| Ph | 3.97 | 3.88 |
| Brix (° Bx, w/w) | 76.6 | 80.0 |
| Water activity (a_{w}) | 0.68 | NA |
| Texture | | |
| Organoleptic Evaluation | Soft elastic | Medium-firm |
| | | elastic |
| Springiness | NA | 61.9 |
| Cohesiveness | NA | 0.289 |
| Hardness (1) | NA | 11.05 |
| Hardness (2) | NA | 4.53 |

The obtained data show that increasing the content of carrageenan and xanthan has a firming effect on the handleable and aerated gel.

### Example 4

### Honey-Based Snack Bars with Nuts and Fruits

### Preparation—General Procedure:

The following is a general procedure for preparing honey-based bar-shaped products or snack-bars, which exhibit a firm texture and pleasant mouth-feel. In some embodiments, the firm honey-based bar-shaped products are prepared with whole nuts or nut chips, seeds and fruit bits, such as raisins, cranberries, dried cherries, citrus peels, dried strawberry and the likes, and also with high-fiber grains such as rolled oats, rice-puffs and the likes.

The process for the preparation of honey-based snack bars with nuts and fruits is similar to the process for the preparation of handleable honey-based products presented hereinabove (see, Example 1), with an exception that the nuts and dried fruits mixes are added and mixed into the hot honey-based liquid formulation, such that the content ratio presented in Table 8 below, namely 70% hot honey-based liquid formulation and 30% nut and fruit mix, is achieved.

Xanthan Gum can also be added to the formulation in order to increase the viscosity of the hot liquid formulation, thereby suspending the solid and insoluble nuts and fruit bits in the matrix of the slowly cooling and solidifying liquid formulation.

The final hot honey-based liquid formulation is mixed with the nut and fruit mix prior to molding/cutting, cooling and coating.

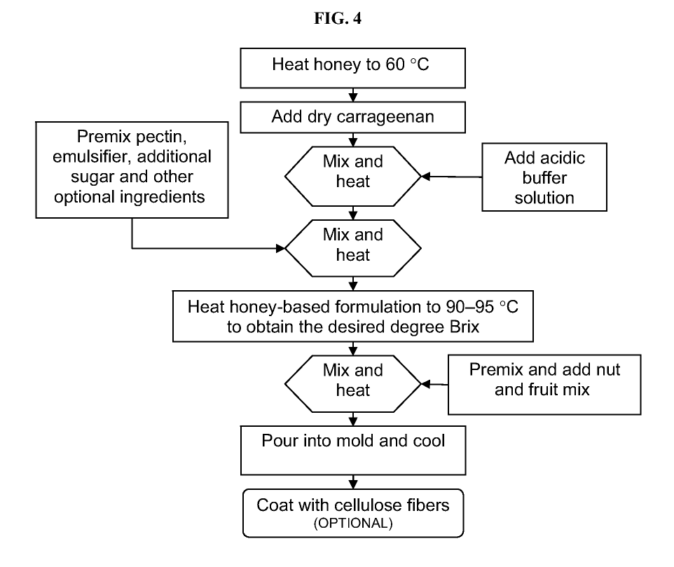

FIG. 4 is a flow-chart presenting an exemplary process of preparing the honey-based snack bar products according to some embodiments of the present invention.

Tables 6, 7 and 8 below provide an exemplary formulation for the above-described embodiment of solid honey-based bar-shaped products enriched with nuts and fruits. Table 6 provides the formulation of the basic honey-based mixture, Table 7 provides the composition of the nut and dried fruit mix, and Table 8 provides the ratio between the honey-based liquid formulation and the nut and fruit mix.

TABLE 6

Sample
number

| | |
|---|---|
| 063A | 065 |

| | |
|---|---|
| Ingredient | Content |

| | | |
|---|---|---|
| Natural honey | 65.7% | 65.7% |
| Tap Water | 13.1% | 13.1% |
| Fructose | 17.5% | 17.5% |
| Carrageenan | 0.9% | 0.9% |
| Pectin (rapid set) | 1.1% | 1.1% |
| Citric acid (50% aq. | 1.0% | 1.0% |
| sol.) | | |
| Trisodium citrate | 0.4% | 0.4% |
| Sucrose ester | 0.3% | 0.3% |
| (emulsifier) | | |
| Total | 100% | 100% |

TABLE 7

| | Code number | |
|---|---|---|
| | 063A | 065 |
| Ingredient | Content | |
| Nuts (A) | 25% chopped almonds | 25% roasted pecans |
| Nuts (B) | 50% chopped Brazil nuts | 50% roasted Brazil |
| | and/or pecans, cashews, | nuts & almonds |
| | pistachio | |
| Dried fruits: | 25% | 25% |
| cranberries and/or | | |
| cherries, “fruit of the | | |
| forest mix” | | |
| Total | 100% | 100% |

TABLE 8

| Ingredient | Content |
|---|---|
| Hot honey based liquid | 70% |
| formulation | |
| Nut and fruit mix | 30% |
| Total | 100% |

Table 9 below provides an exemplary formulation for the above-described embodiment of the honey-based snack bar products enriched with fruits and nuts.

TABLE 9
Product Honey-based snack bar with nuts and fruits

| Sample number | | 063A | 065 |
|---|---|---|---|
| Ingredients | Honey | 46% | 46.0% |
| | Fructose | 12.2% | 17.5% |
| | Nuts | 17.5% | 35.0% |
| | Cranberries | — | 17.5% |

| | | |
|---|---|---|
| Pectin Type | Rapid set | Rapid set |
| pH | 3.65 | 3.83 |
| Brix (° Bx, w/w) | 82.8 | 78.0 |
| Water activity (aw) | 0.69 | — |
| Texture - | Firm gel with | Medium-firm, |
| Organoleptic Evaluation | crunchy nuts | elastic gel |
| | | with crunchy nuts |

### Example 5

### Handleable Honey-Based Products with Fruit Juices and Bioactive Fruit and Natural Vegetable Extracts

The following is an exemplary general procedure for preparing handleable honey-based products enriched with fruit juice concentrates and natural bioactive extracts which include phytochemicals such as carotenoids and polyphenols. These products exhibit unique tastes and color and pleasant mouth-feel, along with the functional bioactive properties of the plants.

### Preparation of Honey and Pomegranate Products—General Procedure:

Honey (40-80 parts by weight) and pomegranate juice concentrate (12 parts by weight) are mixed together and preheated to 60° C. in a stainless steel vessel. The following ingredients are added to the heated honey and pomegranate mixture in the following order: carrageenan powder (0.86-0.93 parts by weight), water (26.1-26.8 parts by weight), trisodium citrate (0.37-0.41 parts by weight) and citric acid (50% solution, 0.67 parts by weight). Thereafter, a mixture of sugar(s), such as fructose or brown cane sugar, (18.4-20.8 parts by weight), pectin (1.03-1.05 parts by weight) and sucrose fatty acids ester as an emulsifying agent (0.24-0.25 parts by weight) is added thereto. The resulting mixture is stirred at a temperature of 90-95° C. until all solids are dissolved and a certain ° Bx is achieved (from about 76° Bx to about 82° Bx). The hot mixture is there after molded to desired shapes and air-cooled. The resulting solid shapes are coated with natural cellulose fibers to prevent stickiness.

The amount of sugars added by fruit juice concentrate is taken in consideration for adjusting the amount of the added sugars.

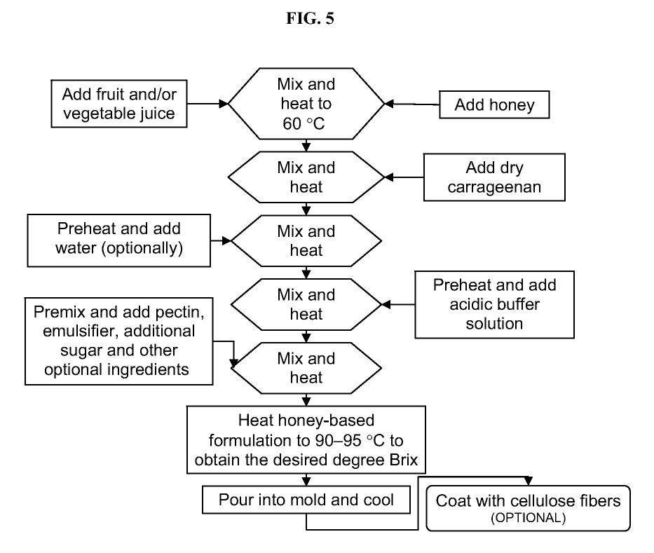

FIG. 5 is a flow-chart presenting an exemplary process of preparing the handleable honey-based products enriched with fruit juice according to some embodiments of the present invention.

Table 10 below provides an exemplary formulation for the above-described embodiment of honey-based snack-bar with pomegranate juice.

TABLE 10

| | Content | |
|---|---|---|
| Sample number | 069 | |
| Ingredients | Natural honey | 40.00% |
| | Water | 26.40% |
| | Fructose | 18.40% |
| | Pomegranate juice concentrate | 12.00% |
| | (65 ° Bx) | |
| | Pectin (rapid Set) | 1.03% |
| | Carrageenan | 0.87% |
| | Citric acid (50% aq. sol.) | 0.67% |
| | Trisodium citrate | 0.39% |
| | Sucrose ester | 0.24% |
| Total | | 100% |

| | |
|---|---|
| pH | 3.38 |
| Brix (° Bx, w/w) | 75.00 |
| Texture - Organoleptic | Firm elastic |
| Evaluation | |
| Color | Deep purple |
| Taste | Sweet/sour typical to pomegranate |

Preparation of Handleable Honey-Based Products Enriched with Orange and Carrot Juice—General Procedure:

Honey (42.2 parts by weight), orange juice concentrate (12.5 parts by weight) are mixed together and preheated to 60° C. in a stainless steel vessel.

The following ingredients are added to the heated honey and orange mixture in the following order: carrageenan powder (1.05-1.08 parts by weight), water (5.83-5.85 parts by weight), trisodium citrate (0.40-0.41 parts by weight) and citric acid (50% solution, 0.75 parts by weight). Thereafter, a mixture of sugar(s), such as fructose (20.85-21.1 parts by weight), pectin (1.08-1.10 parts by weight) and sucrose fatty acids ester as an emulsifying agent (0.25 parts by weight) is added thereto. The resulting mixture is stirred at a temperature of 90-95° C. until all solids are dissolved and a certain ° Bx is achieved (from about 76° Bx to about 82° Bx). Natural carrot extract (“Nutrifood” by GNT Europa GmbH, Aachen, Germany) is thereafter added to the hot mixture and stirred vigorously, and thereafter molded to desired shapes and air-cooled. The resulting solid-gel shapes are coated with natural cellulose fibers to prevent stickiness.

The amount of sugar added by the fruit juice concentrate is taken in consideration for adjusting the amount of the added sugars.

Table 11 below provides an exemplary formulation for the above-described embodiment of handleable honey-based product enriched with orange juice and bioactive carrot extract.

TABLE 11

| | Content | |
|---|---|---|
| Sample number | 070 | |
| Ingredients | Natural honey | 42.20% |
| | Water | 18.38% |
| | Fructose | 20.85% |
| | Orange juice concentrate (62 ° Bx) | 12.50% |
| | Carrot extract | 2.5% |
| | Pectin (rapid Set) | 1.08% |
| | Carrageenan | 1.08% |
| | Citric acid (50% aq. sol.) | 0.75% |
| | Trisodium citrate | 0.41% |
| | Sucrose ester | 0.25% |
| Total | | 100% |

| | |
|---|---|
| PH | 3.80 |
| Brix (° Bx, w/w) | 74.40 |
| Texture - Organoleptic | Firm elastic |
| Evaluation | |
| Color | Orange |
| Taste | Sweet, little sour typical |
| | to orange and carrot juice |

### Example 6

### Consolidated Results of the Texture Profile Analysis

Presented below are various samples of honey-based products, according to some embodiments of the invention:

Samples of handleable honey based products highly soluble in hot water include:

Sample 057A, prepared with rapid set pectin; and

Sample 058B, prepared made with slow set pectin.

Samples of aerated solid honey based bars include:

Sample 059A, containing 0.96% carrageenan, 0.04% xanthan gum, and 0.021% ammonium bicarbonate; and

Sample 059, containing 1.13% carrageenan, 0.09% xanthan gum, and 0.026% ammonium bicarbonate.

Samples 064 and 070, containing pumpkin extract (GNT) or carrot extract (GNT) respectively.

All other ingredients are as in formulation 059B, presented in Table 5 above.

Table 12 below consolidates the results which were obtained in the physico-mechanical assays conducted for several exemplary handleable honey-based products according to some embodiments of the invention, and shows that the honey-based products presented herein can be afforded with full and tunable control over the physico-mechanical properties of the final products, attained by careful selection of the ingredients;, and particularly the type and ratio of various gelling agents.

TABLE 12

| | | Hardness1 | Hardness2 | | Springiness |
|---|---|---|---|---|---|
| Sample | Probe | (N) | (N) | Cohesiveness | (%) |
| A059 | 100 N | 8.03 | 3.87 | 0.384 | 51.1 |
| B059 | 100 N | 11.05 | 4.53 | 0.289 | 61.9 |
| A057 | 100 N | 10.3 | 5.91 | 0.355 | 64.3 |
| 064/070 | 10 N | 3.96 | 1.56 | 0.535 | 62.7 |
| B057 | 10 N | 5.319 | 3.67 | 0.62 | 64.6 |

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1-39. (canceled)

40. A honey-based composition comprising:
a natural honey at a concentration ranging from 40 to 85 percents by weight of the total weight of the composition;
a carrageenan at a concentration ranging from 0.6 to 1.5 percents by weight of the total weight of the composition;
a pectin at a concentration ranging from 0.4 to 1.5 percents by weight of the total weight of the composition;
an acidic buffer at a concentration ranging from 0.5 to 2 percents by weight of the total weight of the composition; and
an emulsifier at a concentration ranging from 0.2 to 1.0 percent by weight of the total weight of the composition.

41. The honey-based composition of claim 40, further comprising a thermo-reversible gelling agent at a concentration ranging from 0.01 to 0.5 percents by weight of the total weight of the composition.

42. The honey-based composition of claim 40, further comprising a thickening agent at a concentration ranging from 0.001 to 0.1 percents by weight of the total weight of the composition.

43. The honey-based composition of claim 40, characterized by a water activity that ranges from 0.6 to 0.8.

44. The honey-based composition of claim 40, characterized by a degree Brix that ranges from 76° Bx to 83° Bx.

45. The honey-based composition of claim 40, being highly dissolvable in hot aqueous media.

46. The honey-based composition of claim 45, wherein a sample of 12 grams thereof dissolves in 100 ml of water at a temperature ranging from 70° C. to 95° C. within a time period that ranges from 60 seconds to 20 seconds.

47. The honey-based composition of claim 40, wherein said carrageenan is kappa-carrageenan.

48. The honey-based composition of claim 40, wherein said pectin is selected from the group consisting of a low ester pectin (LEP), a rapid-set high ester pectin (RSHEP) and a slow-set high ester pectin (SSHEP).

49. The honey-based composition of claim 40, wherein said emulsifier is a sucrose-fatty acid ester.

50. The honey-based composition of claim 40, further comprising an additional sugar source.

51. The honey-based composition of claim 40, wherein:
said carrageenan is kappa-carrageenan;
said pectin is a slow-setting pectin; and
a concentration of said emulsifier ranges from 0.4 to 1.0 percent by weight of the total weight of the composition,
the composition further comprising a thermo-reversible gelling agent at a concentration ranging from 0.1 to 0.5 percent by weight of the total weight of the composition;
the composition being highly dissolvable in hot aqueous media.

52. The honey-based composition of claim 51, wherein said thermo-reversible gelling agent is a low-acyl gellan gum.

53. The honey-based composition of claim 51, wherein a sample of 12 grams thereof dissolves in 100 ml of water at a temperature ranging from 70° C. to 95° C. within a time period that ranges from 40 seconds to 20 seconds.

54. The honey-based composition of claim 40, wherein:
said carrageenan is kappa-carrageenan;
said pectin is a slow-setting pectin; and
a concentration of said emulsifier ranges from 0.2 to 0.4 percent by weight of the total weight of the composition,
the composition being highly dissolvable in hot aqueous media.

55. The honey-based composition of claim 54, wherein a sample of 12 grams thereof dissolves in 100 ml of water at a temperature ranging from 70° C. to 95° C. within a time period that ranges from 60 seconds to 30 seconds.

56. The honey-based composition of claim 54, characterized by springiness that ranges from 50 percents to 70 percents.

57. The honey-based composition of claim 54, characterized by cohesiveness that ranges from 0.2 to 0.7.

58. The honey-based composition of claim 54, further comprising a fruit extract, a vegetable extract, a herb extract, a fruit juice concentrate and/or a vegetable juice concentrate.

59. The honey-based composition of claim 54, further comprising an aeration agent.

60. The honey-based composition of claim 40, wherein:
said carrageenan is kappa-carrageenan;
said pectin is a rapid-setting pectin; and
a concentration of said emulsifier ranges from 0.2 to 0.4 percent by weight of the total weight of the composition,
the composition further comprising:
a solid and insoluble food ingredient at a content ranging from 0 to 30 percent by weight of the total weight of the composition; and
a thickening agent at a concentration ranging from 0.01 to 0.1 percent by weight of the total weight of the composition.

61. The honey-based composition of claim 60, wherein said thickening agent is xanthan gum.

62. The honey-based composition of claim 60, characterized by springiness that ranges from 50 percents to 70 percents.

63. The honey-based composition of claim 60, characterized by cohesiveness that ranges from 0.2 to 0.7.

64. The honey-based composition of claim 60, further comprising an aeration agent.

65. The honey-based composition of claim 40, being identified for use in the manufacture of a product selected from the group consisting of a comestible confectionery product, a dietary supplement, a cosmetic product and a pharmaceutical product.

66. A honey-based product comprising the composition of claim 40.

67. The honey-based product of claim 66, further comprising a coating which comprises natural cellulose fibers.

68. A honey-based product comprising the composition of claim 51, the product being a spoonable honey-based product.

69. The honey-based product of claim 68, being packaged in a packaging material suitable for a spoonable product and identified as a sweetener or a spread.

70. A honey-based product comprising the composition of claim 54, the product being a handleable honey-based product.

71. The honey-based product of claim 70, further comprising a coating which comprises natural cellulose fibers.

72. The honey-based product of claim 70, being packaged in a packaging material.

73. The honey-based product of claim 70, being packaged in a packaging material suitable for a handleable product and identified as a product selected from the group consisting of a sweetener, a confectionary, a candy and a snack bar.

74. A honey-based product comprising the composition of claim 60, the product being a snack-bar honey-based product.

75. The honey-based product of claim 74, further comprising a coating which comprises natural cellulose fibers.

76. The honey-based product of claim 74, being packaged in a packaging material.

77. The honey-based product of claim 74, being packaged in a packaging material suitable for a handleable product and identified as a product selected from the group consisting of a sweetener, a confectionary, a candy and a snack bar.

78. A process of manufacturing the honey-based composition of claim 40, the process comprising:
heating said honey to about 60° C.;
admixing a dry powder of said carrageenan;
adding an aqueous solution which comprises said acidic buffer, said pectin, said additional sugar source and said emulsifier, to thereby obtain a hot honey-based liquid formulation; and
reheating and stirring said hot honey-based liquid formulation to a temperature that ranges from 80-95° C., thereby obtaining the honey-based composition or product.

79. The process of claim 78, further comprising, prior to said adding, mixing, heating and solubilizing said aqueous solution.
